(19) United States
(12) Patent Application Publication
(10) Pub. No.: US 2026/0301231 A1
(43) Pub. Date: Oct. 1, 2026

(54) HIGH-LEVEL SYNTAX FOR MESH CODING

(71) Applicant: InterDigital CE Patent Holdings, SAS, Paris (FR)

(72) Inventors: Gurdeep Bhullar, London (GB); Julien Ricard, Plouër-sur-Rance (FR); Olivier Mocquard, Rennes (FR); Ahmed Hamza, Coquitlam (CA)

(21) Appl. No.: 19/474,964

(22) PCT Filed: Apr. 15, 2024
(86) PCT No.: PCT/EP2024/060122

§ 371 Date: Oct. 13, 2025

(30) Foreign Application Priority Data
Apr. 21, 2023 (EP) 23315093.7
Jan. 16, 2024 (EP) 24305103.4

(51) Int. Cl. G06T 9/00

(52) U.S. Cl. CPC G06T 9/001

(57) ABSTRACT

Systems and methods are described for encoding and decoding of 3D volumetric data. Volumetric data is encoded and/or decoded using a syntax that allows for different codec types, such as a point-cloud-based codec type (e.g., V-PCC), a mesh-based codec type (e.g. V-DMC), and a depth-image-based codec type (e.g. MIV). Example encoding and decoding techniques improve bitrates by allowing for syntax elements that are specific to different codec types, such as syntax elements related to atlas coding, to be signaled conditionally, e.g. only when the corresponding codec type is used for the volumetric coding. Some embodiments allow for further improvement in bitrates by inferring atlas tile header syntax element formats from NAL unit type parameters.

### CROSS-REFERENCE

This application claims priority of European Patent Application No. 23315093.7, filed 21 Apr. 2023, and European Patent Application No. 24305103.4, filed 16 Jan. 2024, both of which are incorporated herein by reference in their entirety.

### BACKGROUND

The present disclosure relates to systems and method for encoding and decoding (collectively, “coding”) of 3D volumetric data.

Conventional immersive video allows a user to experience a scene while looking around in all different directions. The user has the ability to change their viewing direction (e.g. the orientation of their head, when the user is viewing through a head-mounted display), and the correct view is displayed to the user based on that viewing direction. Because the viewing direction can be described by three parameters (such as altitude, azimuth, and roll angles), video that is adaptive to a user's selection of viewing direction is referred to as a three degree of freedom (3DoF) experience. A 3DoF experience, however, does not provide for motion parallax. That is, the viewing experience does not adapt to changes in the user's viewing position, as opposed to their viewing direction. Such a limitation provides for a less immersive experience, and it can also contribute to user discomfort during the viewing experience.

To address such issues, efforts are being made to develop a six degree of freedom (6DoF) experience that accommodates not only the three dimensions of a user's viewing direction but also the three dimensions (x, y, z) of the user's motion in physical space. Some of these efforts involve the creation of standardized video encoding and decoding systems and method to efficiently convey the data needed to provide a 6DoF experience. One such effort is referred to as visual volumetric video-based coding (V3C). V3C provides a framework for the coding of 6DoF experiences. However, the current V3C framework is developed primarily around volumetric coding using point cloud geometries, particularly using the V-PCC system of video based point cloud compression. Some accommodation is also made in V3C for the use of other volumetric encoding techniques, such as MPEG immersive video (MIV). However, the encoding of volumetric experiences using V3C is not optimized when coding types other than V-PCC are used.

### SUMMARY

Systems and methods are described for encoding and decoding of 3D volumetric data. Volumetric data is encoded and/or decoded using a syntax that allows for different codec types, such as a point-cloud-based codec type (e.g., V-PCC), a mesh-based codec type (e.g. V-DMC), and a depth-image-based codec type (e.g. MIV). Example encoding and decoding techniques improve bitrates by allowing for syntax elements that are specific to different codec types, such as syntax elements related to atlas coding, to be signaled conditionally, e.g. only when the corresponding codec type is used for the volumetric coding. Some embodiments allow for further improvement in bitrates by inferring atlas tile header syntax element formats from NAL unit type parameters.

A method in some embodiments comprises: encoding volumetric input data with mesh-based 3D volumetric coding; wherein encoding the volumetric input data comprises encoding an atlas for the mesh-based 3D volumetric coding; wherein encoding the atlas includes: encoding, in a sequence parameter set of the atlas, a flag indicating that parameters are provided for an atlas type associated with mesh-based coding; and encoding, in the sequence parameter set, the parameters for the atlas type associated with mesh-based coding.

In some such methods, the mesh-based 3D volumetric coding is V-DMC coding.

Some methods further include encoding, in the sequence parameter set, a flag indicating that parameters are not provided for an atlas type associated with point-cloud-based coding. In some such embodiments, the point-cloud-based coding is V-PCC coding.

In some embodiments, a method comprises: encoding volumetric input data with 3D volumetric coding; wherein encoding volumetric input data comprises encoding an atlas for the 3D volumetric coding; wherein encoding the atlas includes: encoding, in a sequence parameter set of the atlas, a flag indicating whether parameters are provided for an atlas type associated with point-cloud-based coding; and encoding, in the sequence parameter set, the parameters for the atlas type associated with point-cloud-based coding, wherein at least one of the following parameters is encoded only in response to the flag indicating that parameters are provided for an atlas type associated with point-cloud-based coding:

| asps_use_eight_orientations_flag, | asps_extended_projection_enabled_flag, |
|---|---|
| asps_max_number_projections_minus1, | |

asps_normal_axis_limits_quantization_enabled_flag,

asps_normal_axis_max_delta_value_enabled_flag, asps_patch_precedence_order_flag,

| asps_log2_patch_packing_block_size, | asps_patch_size_quantizer_present_flag, | |
|---|---|---|
| asps_map_count_minus1, | asps_pixel_deinterleaving_enabled_flag, | |
| asps_map_pixel_deinterleaving_flag, | | asps_raw_patch_enabled_flag, |
| asps_eom_patch_enabled_flag, | | |

asps_eom_fix_bit_count_minus1,asps_auxiliary_video_enabled_flag, or

asps_plr_enabled_flag.

In some embodiments, a method comprises: encoding volumetric input data with a point-cloud-based 3D volumetric coding; wherein encoding the volumetric input data comprises encoding an atlas for the point-cloud-based 3D volumetric coding; wherein encoding the atlas includes: encoding, in a frame parameter set of the atlas, a flag indicating whether parameters are provided for an atlas type associated with the point-cloud-based coding; and encoding, in the frame parameter set, the parameters for the atlas type associated with the point-cloud-based coding.

In some embodiments, a parameter afps_raw_3d_offset_bit_count_explicit_mode_flag associated with the point-cloud-based coding is encoded in the frame parameter set only in response to the flag indicating that parameters are provided for an atlas type associated with the point-cloud-based coding.

A method according to some embodiments comprises: encoding volumetric input data with a mesh-based 3D volumetric coding; wherein encoding the volumetric input data comprises encoding an atlas for the mesh-based 3D volumetric coding; wherein encoding the atlas includes: encoding, in a frame parameter set of the atlas, a flag indicating whether parameters are provided for an atlas type associated with the mesh-based coding; and encoding, in the frame parameter set, the parameters for the atlas type associated with the mesh-based 3D volumetric coding.

A method according to some embodiments comprises selecting a coding type for the encoding of volumetric input data with 3D volumetric coding; and encoding an atlas for the 3D volumetric coding; wherein encoding the atlas includes: encoding, in a video parameter set of the atlas, at least one parameter indicating the codec type of the 3D volumetric coding.

In some embodiments, the at least one parameter indicating a codec type indicates a codec type from among at least a point-cloud-based codec type (e.g. V-PCC), a mesh-based codec type (e.g. V-DMC), and a depth-image-based codec type (e.g. MIV).

In some embodiments, the at least one parameter indicating a codec type is a single parameter, the value of the single parameter indicating the codec type.

In some embodiments, the at least one parameter indicating a codec type comprises a plurality of flags, each flag corresponding to a codec type.

A method according to some embodiments comprises: encoding volumetric input data with 3D volumetric coding; wherein encoding the volumetric input data comprises encoding an atlas for the 3D volumetric coding; wherein encoding the atlas includes: encoding a type parameter indicating a codec type of the 3D volumetric coding; and encoding, in an atlas tile header, atlas parameters for an atlas type associated with point-cloud-based coding, wherein at least one of the following parameters is encoded only in response to the type parameter indicating a point-cloud-based codec type:

| | |
|---|---|
| ath_pos_min_d_quantizer, | ath_pos_delta_max_d_quantizer, |

| | |
|---|---|
| ath_patch_size_x_info_quantizer, | ath_patch_size_y_info_quantizer, or |

ath_raw_3d_offset_axis_bit_count_minus1.

In some embodiments, the type parameter is encoded in a video parameter set of the atlas.

In some embodiments, the type parameter indicates a codec type from among at least a point-cloud-based codec type, a mesh-based codec type, and a depth-image-based codec type.

In some embodiments, the type parameter indicates a codec type from among at least V-PCC, V-DMC, and MIV.

A method according to some embodiments comprises: encoding volumetric input data with 3D volumetric coding; wherein encoding the volumetric input data comprises encoding an atlas for the 3D volumetric coding; wherein encoding the atlas includes: encoding a type parameter indicating a codec type of the 3D volumetric coding; and encoding, in an atlas tile data unit, a set of patch information data selected from among a plurality of available sets of patch information data, wherein the set of patch information data is selected based on the indicated codec type.

In some embodiments, the type parameter is encoded in a video parameter set of the atlas.

In some embodiments, the type parameter indicates a codec type from among at least a point-cloud-based codec type, a mesh-based codec type, and a depth-image-based codec type.

In some embodiments, the type parameter indicates a codec type from among at least V-PCC, V-DMC, and MIV.

A method according to some embodiments comprises: encoding volumetric input data with 3D volumetric coding; wherein encoding the volumetric input data comprises encoding an atlas for the 3D volumetric coding; wherein encoding the atlas includes encoding the atlas using at least one network abstraction layer (NAL) unit, each NAL unit having a NAL unit type parameter; and wherein encoding the atlas further includes encoding an atlas tile header syntax element in a NAL unit, the atlas tile header syntax element having a format based on the NAL unit type parameter.

In some such embodiments, the format of the atlases tile header syntax element is not signaled in the atlas tile header syntax element.

In some embodiments, the format of the atlas tile header syntax element is a format associated with one of the following formats: P_TILE, SKIP_TILE, and I_TILE.

A method in some embodiments comprises: decoding mesh-based 3D volumetric coding data; wherein decoding the mesh-based 3D volumetric coding data comprises decoding an atlas for the mesh-based 3D volumetric coding; wherein decoding the atlas includes: decoding, from a sequence parameter set of the atlas, a flag indicating that parameters are provided for an atlas type associated with mesh-based coding; and decoding, from the sequence parameter set, the parameters for the atlas type associated with mesh-based coding.

In some embodiments, the mesh-based 3D volumetric coding is V-DMC coding.

Some embodiments further comprise decoding, from the sequence parameter set, a flag indicating that parameters are not provided for an atlas type associated with point-cloud-based coding.

A method according to some embodiments comprises: decoding 3D volumetric coded data; wherein decoding the 3D volumetric data comprises decoding an atlas for the 3D volumetric coding; wherein decoding the atlas includes: decoding, from a sequence parameter set of the atlas, a flag indicating whether parameters are provided for an atlas type associated with point-cloud-based coding; and decoding, from the sequence parameter set, the parameters for the atlas type associated with point-cloud-based coding, wherein at least one of the following parameters is decoded only in response to the flag indicating that parameters are provided for an atlas type associated with point-cloud-based coding:

| asps_use_eight_orientations_flag, | asps_extended_projection_enabled_flag, |
|---|---|
| asps_max_number_projections_minus1, | |

asps_normal_axis_limits_quantization_enabled_flag,

asps_normal_axis_max_delta_value_enabled_flag, asps_patch_precedence_order_flag,

| asps_log2_patch_packing_block_size, | asps_patch_size_quantizer_present_flag, | |
|---|---|---|
| asps_map_count_minus1, | asps_pixel_deinterleaving_enabled_flag, | |
| asps_map_pixel_deinterleaving_flag, | | asps_raw_patch_enabled_flag, |
| asps_eom_patch_enabled_flag, | | |

asps_eom_fix_bit_count_minus1,asps_auxiliary_video_enabled_flag, or

asps_plr_enabled_flag.

A method according to some embodiments comprises: decoding point-cloud-based 3D volumetric coding data; wherein decoding the point-cloud-based 3D volumetric data comprises decoding an atlas for the point-cloud-based 3D volumetric coding; wherein decoding the atlas includes: decoding, from a frame parameter set of the atlas, a flag indicating whether parameters are provided for an atlas type associated with the point-cloud-based coding; and decoding, from the frame parameter set, the parameters for the atlas type associated with the point-cloud-based coding.

In some embodiments, a parameter afps_raw_3d_offset_bit_count_explicit_mode_flag associated with the point-cloud-based coding is decoded from the frame parameter set only in response to the flag indicating that parameters are provided for an atlas type associated with the point-cloud-based coding.

A method according to some embodiments comprises: decoding mesh-based 3D volumetric coding data; wherein decoding the mesh-based 3D volumetric coding data comprises decoding an atlas for the mesh-based 3D volumetric coding; wherein decoding the atlas includes: decoding, from a frame parameter set of the atlas, a flag indicating whether parameters are provided for an atlas type associated with the mesh-based coding; and decoding, from the frame parameter set, the parameters for the atlas type associated with the mesh-based coding.

A method according to some embodiments comprises: decoding 3D volumetric coding data; wherein decoding 3D volumetric coding data comprises decoding an atlas for the 3D volumetric coding; wherein decoding the atlas includes: decoding, from a video parameter set of the atlas, at least one parameter indicating a codec type of the 3D volumetric coding; and decoding the atlas according to the codec type.

In some embodiments, the at least one parameter indicating a codec type indicates a codec type from among at least a point-cloud-based codec type and a mesh-based codec type. In some embodiments, the at least one parameter indicating a codec type indicates a codec type from among at least a point-cloud-based codec type, a mesh-based codec type, and a depth-image-based codec type. In some embodiments, the at least one parameter indicating a codec type indicates a codec type from among at least V-PCC, V-DMC, and MIV.

In some embodiments, the at least one parameter indicating a codec type is a single parameter, the value of the single parameter indicating the codec type.

In some embodiments, the at least one parameter indicating a codec type comprises a plurality of flags, each flag corresponding to a codec type.

A method according to some embodiments comprises: decoding 3D volumetric coding data; wherein decoding the volumetric input data comprises decoding an atlas for the 3D volumetric data; wherein decoding the atlas includes: decoding a type parameter indicating a codec type of the 3D volumetric coding; and decoding, from an atlas tile header, atlas parameters for an atlas type associated with point-cloud-based coding, wherein at least one of the following parameters is decoded only in response to the type parameter indicating a point-cloud-based codec type:

| | |
|---|---|
| ath_pos_min_d_quantizer, | ath_pos_delta_max_d_quantizer, |
| ath_patch_size_x_info_quantizer, | ath_patch_size_y_info_quantizer, or |

ath_raw_3d_offset_axis_bit_count_minus1.

According to some such embodiments, the type parameter is decoded from a video parameter set of the atlas.

In some embodiments, the type parameter indicates a codec type from among at least a point-cloud-based codec type, a mesh-based codec type, and a depth-image-based codec type.

In some embodiments, the type parameter indicates a codec type from among at least V-PCC, V-DMC, and MIV.

A method according to some embodiments comprises: decoding 3D volumetric coding data; wherein decoding the 3D volumetric coding data comprises decoding an atlas for the 3D volumetric coding; wherein decoding the atlas includes: decoding a type parameter indicating a codec type of the 3D volumetric coding; and decoding, from an atlas tile data unit, a set of patch information data selected from among a plurality of available sets of patch information data, wherein the set of patch information data is selected based on the indicated codec type.

In some embodiments, the type parameter is decoded from a video parameter set of the atlas.

In some embodiments, the type parameter indicates a codec type from among at least a point-cloud-based codec type, a mesh-based codec type, and a depth-image-based codec type.

In some embodiments, the type parameter indicates a codec type from among at least V-PCC, V-DMC, and MIV.

A method according to some embodiments includes: decoding 3D volumetric coding data; wherein decoding the 3D volumetric coding data comprises decoding an atlas for the 3D volumetric coding, the atlas including at least one network abstraction layer (NAL) unit, each NAL unit having a NAL unit type parameter; determining a format of an atlas tile header syntax element based on the NAL unit type parameter of a NAL unit containing the atlas tile header syntax element; and decoding the atlas tile header syntax element based on the determined format.

In some such embodiments, the format of the atlases tile header syntax element is not signaled in the atlas tile header syntax element.

In some embodiments, the format of the atlas tile header syntax element is a format associated with one of the following formats: P_TILE, SKIP_TILE, and I_TILE.

Some embodiments include an encoder comprising one or more processors configured to perform the methods described herein.

Some embodiments include a bitstream encoded using the methods described herein.

Some embodiments include a computer-readable medium storing a bitstream encoded using the methods described herein. The medium may be a non-transitory medium.

Some embodiments include a computer-readable medium storing instructions operative, when executed on one or more processors, to perform the methods described herein. The medium may be a non-transitory medium.

Some embodiments include a decoder comprising one or more processors configured to perform the methods described herein.

### BRIEF DESCRIPTION OF THE DRAWINGS

FIG. 1 is a functional block diagram illustrating an intra frame encoding process.

FIG. 2 is a functional block diagram illustrating an inter frame encoding process.

FIG. 3 is a functional block diagram illustrating an intra frame decoding process.

FIG. 4 is a functional block diagram illustrating an inter frame decoding process.

FIGS. 5A-5B illustrate an example relationship between the nal_unit_type parameter and the corresponding semantics as used in V3C.

FIG. 6 illustrates an overview of an example V3C bitstream structure.

FIG. 7 illustrates an example atlas NAL structure.

FIG. 8 is a block diagram of an example of a system in which various aspects and embodiments are implemented.

FIG. 9 is a flow diagram of a decoding method according to some embodiments.

FIG. 10 is a flow diagram of an encoding method according to some embodiments.

### DETAILED DESCRIPTION

### Overview of Example Embodiments

Example embodiments provide a generalized high-level syntax for atlas bitstreams. Example embodiments use a generic and flexible syntax which can be further extended to be used for different 3D content compression schemes such as V-PCC, V-DMC and future extensions. Further embodiments reduce the bitstream size needed to store atlas data depending on the type of data transmitted. Types of atlases may include V-PCC, MIV and V-DMC. Example embodiments reduce the bitstream size for the three codecs.

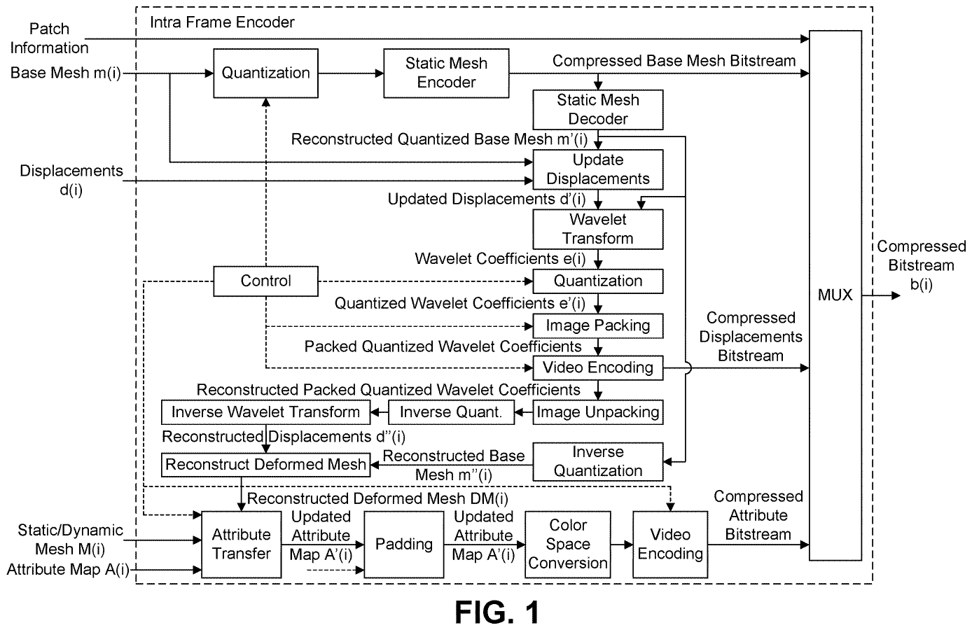

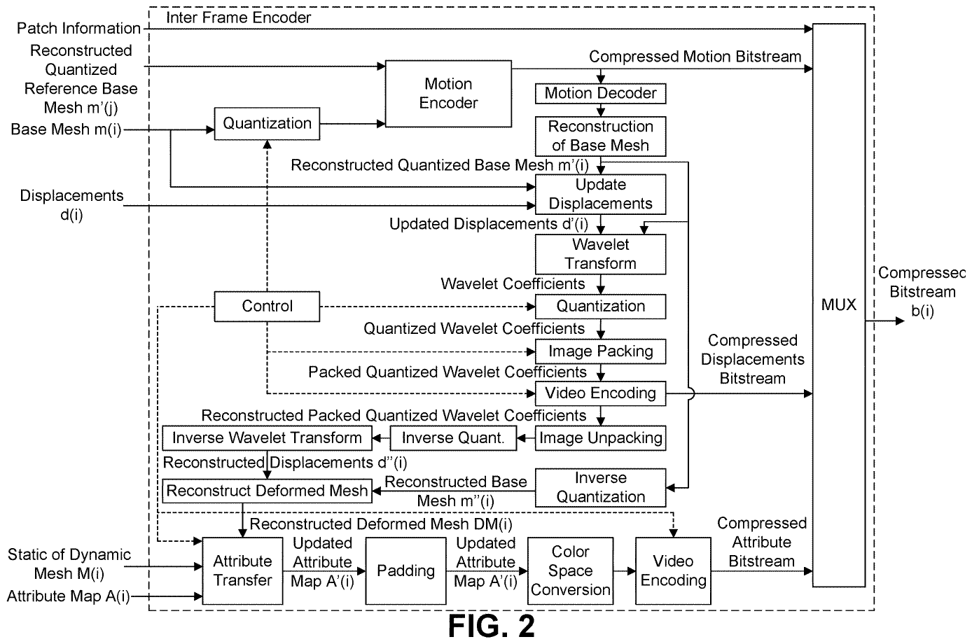

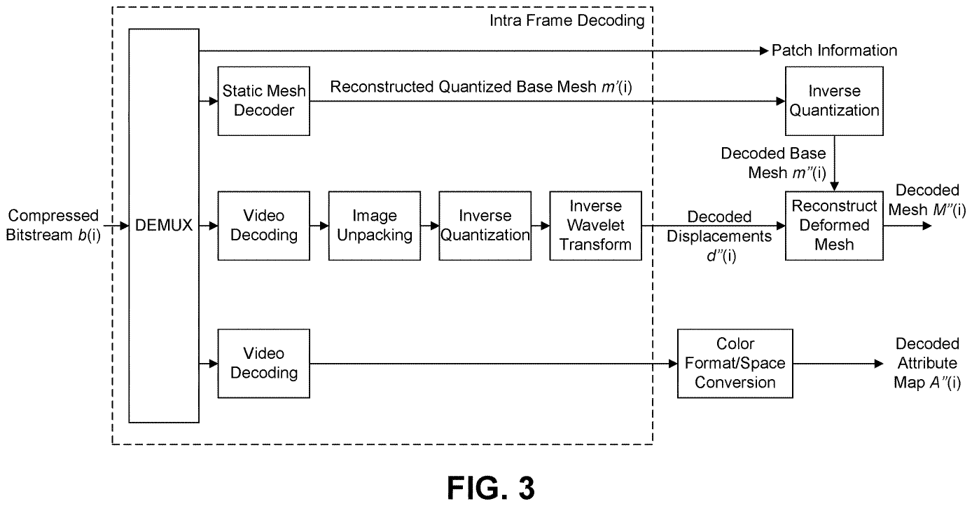

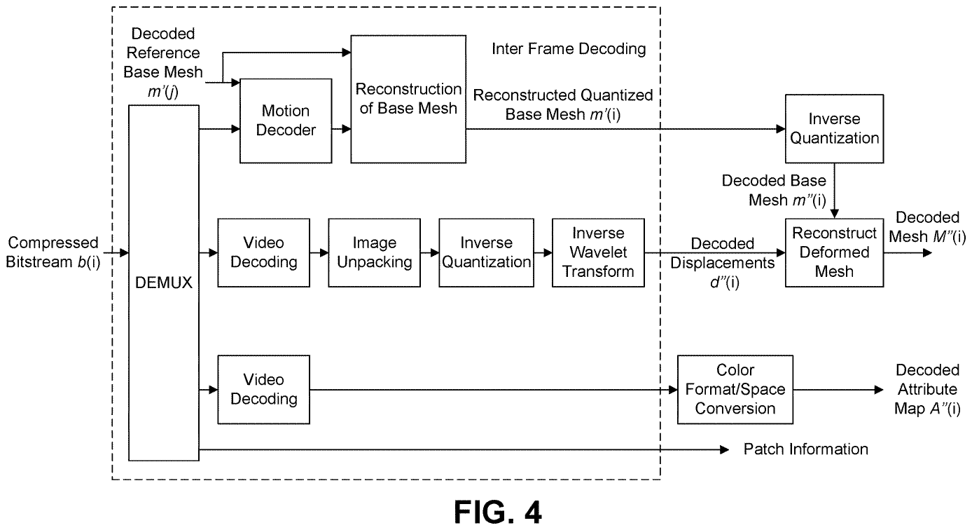

One known coding system for dynamic mesh models, such as the MPEG V-Mesh Test Model, is described in K. Mammou, J. Kim, A. Tourapis and D. Podborski, “m59281—[V-CG] Apple's Dynamic Mesh Coding CfP Response,” Apple Inc, 2022. An overview of such an example process is provided in FIGS. 1-4. FIG. 1 illustrates an intra frame encoding process. FIG. 2 illustrates an inter frame encoding process. FIG. 3 illustrates an intra frame decoding process. FIG. 4 illustrates an inter frame decoding process.

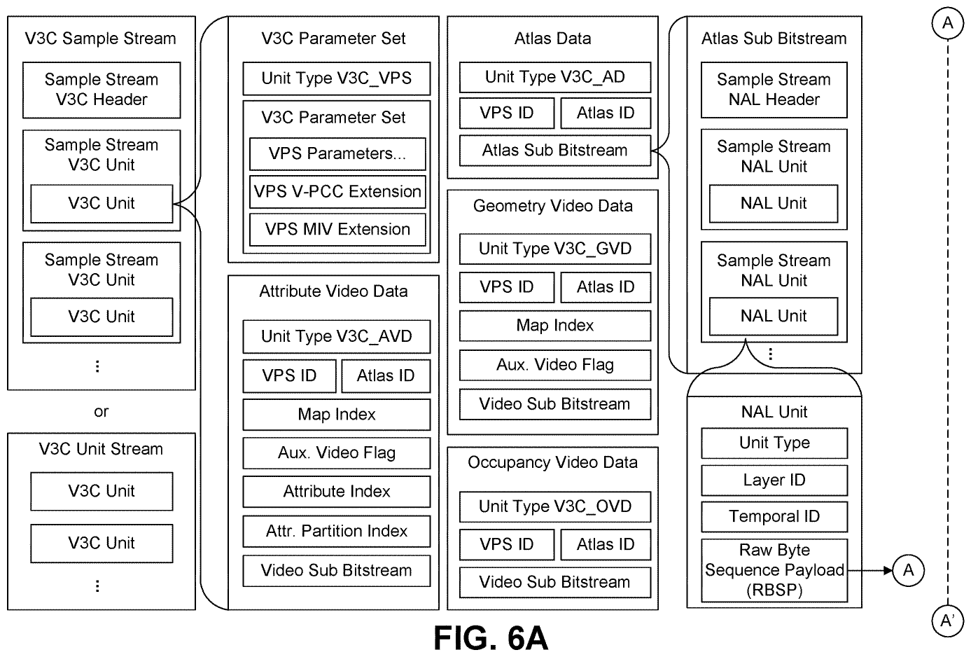

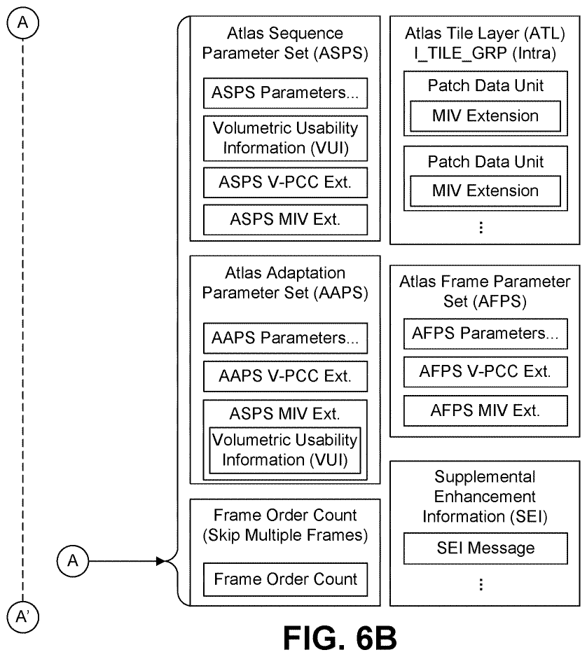

An overview of an example V3C bitstream structure is shown in FIG. 6. The bitstream structure is described in, for example, Boyce, J. M. et al., “MPEG Immersive Video Coding Standard,” Proc. IEEE 109 (9), 1521-1536. doi:10.1109/jproc.2021.3062590 (2021).

Currently, the V-Mesh test model proposes a motion detection stage where two variants of a mesh are candidates for a frame: the original base mesh M′ₛ(i) (see FIGS. 1 and 3 for the static path), or a base mesh using the topology of the previous frame M′ₘ(i) (see FIGS. 2 and 4 for the motion path). In the later case, some encoding of the vertex motion is used, and the topology is skipped since the topology from the previous frame is used.

Embodiments of the present disclosure are described with particular reference to the visual volumetric video-based coding (V3C) bitstream. Some such embodiments result in an improvement of the V3C bitstream to reduce the size of the data needed to be transmitted to decode a bitstream, such as a V-DMC (video-based dynamic mesh coding) bitstream, an MIV (MPEG Immersive video) bitstream, and/or a V-PCC (Video-based Point Cloud Compression) bitstream. The inventive concepts described herein are not however limited to use in a V3C bitstream.

Example embodiments of the present disclosure introduces a new syntax definition to describe an atlas sub-bitstream, such as a sub-bitstream in V3C. The example atlas sub-bitstream is aimed to be flexible. The flexibility in the atlas sub-bitstream allows for the introduction of any 3D content such as point cloud, mesh, or 3DoF+ volumes to be described using the V3C compression scheme.

Some embodiments include one or more of the following features.

In some embodiments, the syntax of an atlas sample stream is configured to allow for different types of data that can be carried, such as V-PCC data, V-DMC data, and/or MIV data. In the current V3C syntax, the atlas is designed to store V-PCC data, and some data stored in the atlas is mandatory but may not be useful to other codecs that use a V3C atlas (such as MIV and V-DMC). Example embodiments provide coding systems and method that can be more efficiently used with various different codecs without requiring the unnecessary inclusion of mandatory data.

In some embodiments, coding systems and methods are provided that make use of a syntax in which a type of data carried by the bitstream is indicated in a video parameter set (VPS). The bitstream in such embodiments may be a V3C bitstream.

In some embodiments, coding systems and methods are provided in which an atlas tile type is not encoded explicitly but rather is deduced implicitly on the decoder side by extracting this information from the atlas sub-bitstream NAL (network abstraction layer) unit type (i.e. nal_unit_type) stored in a NAL unit header i.e. nal_unit_header( ). Such embodiments reduce the amount of data transmitted to represent an Atlas V3C sample stream, for example by removing the atlas tile type parameter (ath_type) from the atlas_tile_header.

Example embodiments provide methods and apparatus using an atlas sample stream syntax that contains the atlas raw byte sequence payloads (RBSP), such as those defined in section “8.3.6 Raw byte sequence payloads, trailing bits, and byte alignment syntax” and section “8.3.7 Atlas tile data unit syntax” as described in the text of ISO/IEC FDIS 23090-5 2nd Edition Visual volumetric video-based coding (V3C) and video-based point cloud compression (V-PCC), ISO/IEC JTC 1/SC 29/WG 7, 23090-5: 2023 (E), MDS22483_WG07_N00553, MDS22483, January 2023.

Example embodiments maker use of an atlas with greater flexibility to be able to carry various type of data (such as V-PCC, MIV or V-DMC) without requiring the inclusion of date that is not used for each codec. Such embodiments help to reduce the bitstream sizes and facilitate the parsing processes.

As comparted to existing V3C, example embodiments include differences in one or more of the following syntax structures.
Atlas sequence parameter set RBSP syntax (8.3.6.1)
Atlas frame parameter set RBSP syntax (8.3.6.2)
Atlas tile header syntax (8.3.6.11)
General atlas tile data unit syntax (8.3.7.1)

In general, these identified sections describe the atlas syntax that is used to carry V-PCC and/or MIV data. However, much of that data is not used in the case of volumetric data coded according to a different scheme, such as V-DMC for instance.

Example embodiments provide a syntax for an atlas sample stream that is more flexible and allows for transporting data of different types without unnecessary overhead. In a syntax according to example embodiments, all the data that are specific to one special codec (V-PCC, MIV or V-DCM) are provided in a corresponding atlas extension. Extensions for V-PCC, MIV, and V-DMC data as used in some embodiments are described herein.

The following tables show syntax tables used in some example embodiments.

TABLE 1
General atlas sequence parameter set RBSP syntax.

| | | Descriptor |
|---|---|---|
| atlas_sequence_parameter_set_rbsp( ) { | | |
| asps_atlas_sequence_parameter_set_id | | ue(v) |
| asps_frame_width | | ue(v) |
| asps_frame_height | | ue(v) |
| asps_geometry_3d_bit_depth_minus1 | | u(5) |
| asps_geometry_2d_bit_depth_minus1 | | u(5) |
| asps_log2_max_atlas_frame_order_cnt_lsb_minus4 | | ue(v) |
| asps_max_dec_atlas_frame_buffering_minus1 | | ue(v) |
| asps_long_term_ref_atlas_frames_flag | | u(1) |
| asps_num_ref_atlas_frame_lists_in_asps | | ue(v) |
| for( i = 0; i < asps_num_ref_atlas_frame_lists_in_asps; i++ ) | | |
| ref_list_struct( i ) | | |
| asps_vui_parameters_present_flag | | u(1) |
| if( asps_vui_parameters_present_flag ) | | |
| vui_parameters( ) | | |
| asps_extension_present_flag | | u(1) |
| if( asps_extension_present_flag ) { | | |
| asps_vpcc_extension_present_flag | | u(1) |
| asps_miv_extension_present_flag | | u(1) |
| asps_vdmc_extension_present_flag | † | u(1) |
| asps_extension_5bits | † | u(5) |
| } | | |
| if( asps_vpcc_extension_present_flag ) | | |
| asps_vpcc_extension( ) /* Specified in Annex H */ | | |
| if( asps_miv_extension_present_flag ) | | |
| asps_miv_extension( ) /* Specified in ISO/IEC 23090-12 */ | | |
| if( asps_vdmc_extension_present_flag ) | † | |
| asps_vdmc_extension( ) | † | |
| if( asps_extension_5bits ) | † | |
| while( more_rbsp_data( ) ) | | |
| asps_extension_data_flag | | u(1) |
| rbsp_trailing_bits( ) | | |
| } | | |

Features marked with a dagger (t) are features that are added or revised in example embodiments as compared to the general atlas sequence parameter set RBSP syntax (V3C Section 8.3.6.1.1).

As reflected in Table 1, a mesh decoding method according to some embodiments includes: decoding mesh-based 3D volumetric coding data, wherein decoding the mesh-based 3D volumetric coding data comprises decoding an atlas for the mesh-based 3D volumetric coding. Decoding the atlas includes decoding first atlas type information from a sequence parameter set of the atlas. In response to a determination that the first atlas type information identifies an atlas type associated with mesh-based coding, a first set of parameters is decoded from the sequence parameter set for the atlas type associated with mesh-based coding.

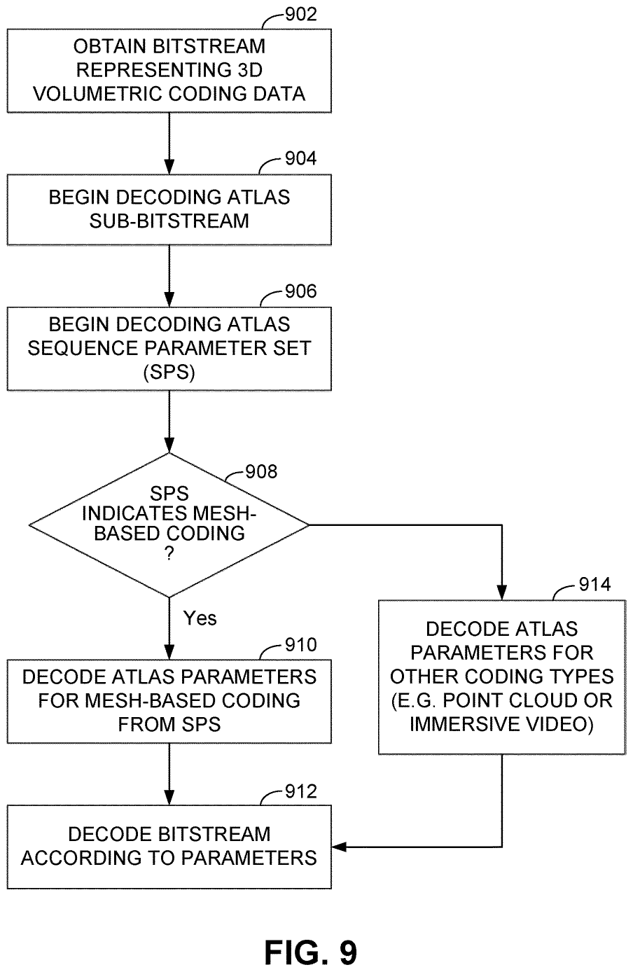

One such mesh decoding method is illustrated in FIG. 9. At 902, a bitstream is obtained that represents 3D volumetric coding data. The bitstream includes an atlas sub-bitstream, and decoding of the atlas sub-bitstream begins at 904. The decoding of the atlas sub-bitstream includes the decoding of an atlas sequence parameter set (SPS), which begins at 906. Within the SPS, first atlas type information is decoded. A determination is made at 908 of whether at least the first atlas type information in the SPS identifies an atlas type associated with mesh-based coding. If so, at 910, a first set of parameters is decoded from the sequence parameter set for the atlas type associated with mesh-based coding. The bitstream may then be decoded according to those parameters at 912. If the atlas type information in the SPS does not identify an atlas type associated with mesh-based coding, then parameters associated with different atlas types may be decoded from the SPS at 914, such as parameters associated with point cloud coding or immersive video coding.

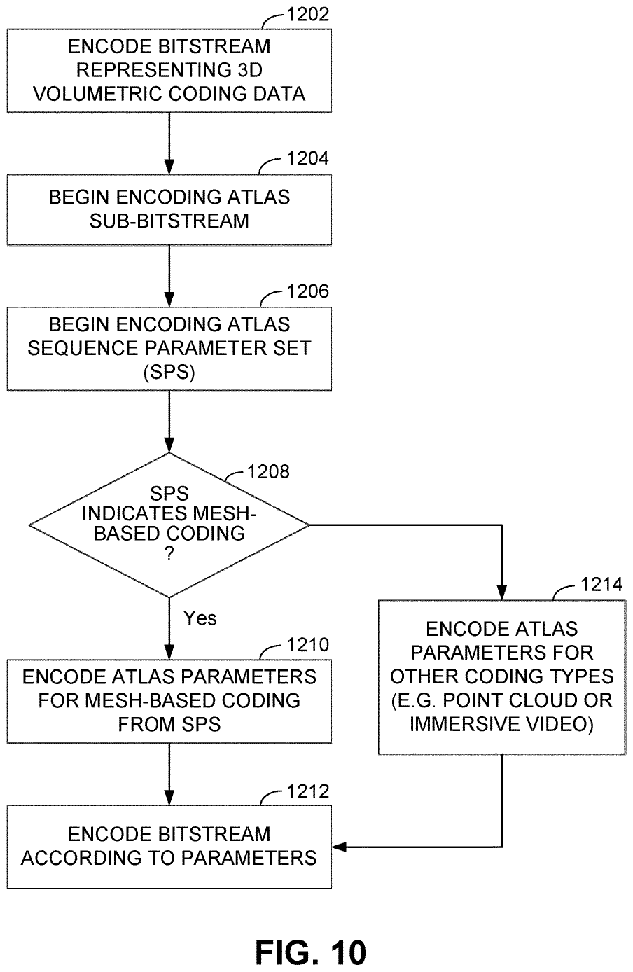

An example of a corresponding encoding method is illustrated in FIG. 10. At 1202, encoding begins for a bitstream that represents 3D volumetric coding data. The bitstream includes an atlas sub-bitstream, and encoding of the atlas sub-bitstream begins at 1204. The encoding of the atlas sub-bitstream includes the encoding of an atlas sequence parameter set (SPS), which begins at 1206. Within the SPS, first atlas type information is encoded. A determination is made at 1208 of whether at least the first atlas type information in the SPS identifies an atlas type associated with mesh-based coding. If so, at 1210, a first set of parameters is encoded in the sequence parameter set for the atlas type associated with mesh-based coding. The bitstream may then be encoded according to those parameters at 1212. If the atlas type information in the SPS does not identify an atlas type associated with mesh-based coding, then parameters associated with different atlas types may be encoded from the SPS at 1214, such as parameters associated with point cloud coding or immersive video coding.

In some such embodiments, the first atlas type information includes a plurality of flags, each flag being associated with a respective atlas type, a first one of the flags being associated with mesh-based coding and having a value indicating that the atlas type is associated with mesh-based coding.

Table 2 illustrates an example of a syntax element used to code parameters associated with V-PCC in an atlas sequence parameter set according to some embodiments. In some embodiments, in response to the determination that the atlas type is associated with mesh-based coding, some or all of the parameters shown in Table 2 are not coded in the sequence parameter set.

TABLE 2
Atlas sequence parameter set V-PCC extension
syntax updated to include specific V-PCC data

| | | Descriptor |
|---|---|---|
| asps_vpcc_extension( ) { | | |
| asps_vpcc_remove_duplicate_point_enabled_flag | | u(1) |
| if( asps_pixel_deinterleaving_enabled_flag ∥ asps_plr_enabled_flag ) | | |
| asps_vpcc_surface_thickness_minus1 | | ue(v) |
| asps_use_eight_orientations_flag | † | u(1) |
| asps_extended_projection_enabled_flag | † | u(1) |
| if( asps_extended_projection_enabled_flag ) | † | |
| asps_max_number_projections_minus1 | † | ue(v) |
| asps_normal_axis_limits_quantization_enabled_flag | † | u(1) |
| asps_normal_axis_max_delta_value_enabled_flag | † | u(1) |
| asps_patch_precedence_order_flag | † | u(1) |
| asps_log2_patch_packing_block_size | † | u(3) |
| asps_patch_size_quantizer_present_flag | † | u(1) |
| asps_map_count_minus1 | † | u(4) |
| asps_pixel_deinterleaving_enabled_flag | † | u(1) |
| if( asps_pixel_deinterleaving_enabled_flag ) | † | |
| for( j = 0; j <= asps_map_count_minus1; j++ ) | † | |
| asps_map_pixel_deinterleaving_flag[ j ] | † | u(1) |
| asps_raw_patch_enabled_flag | † | u(1) |
| asps_eom_patch_enabled_flag | † | u(1) |
| if( asps_eom_patch_enabled_flag && asps_map_count_minus1 == 0 ) | † | |
| asps_eom_fix_bit_count_minus1 | † | u(4) |
| if( asps_raw_patch_enabled_flag ∥ asps_eom_patch_enabled_flag ) | † | |
| asps_auxiliary_video_enabled_flag | † | u(1) |
| asps_plr_enabled_flag | † | u(1) |
| if( asps_plr_enabled_flag ) | † | |
| asps_plr_information( asps_map_count_minus1 ) | † | |
| } | | |

Features marked with a dagger (t) are features that are added or revised in example embodiments as compared to the ASPS V-PCC extension syntax (V3C Section H.8.3.6.1.3).

Table 3 illustrates an example of a syntax element used to code parameters associated with V-DMC in an atlas sequence parameter set (ASPS) according to some embodiments. Such a syntax element may be used to convey a set of parameters for an atlas type associated with mesh-based coding.

TABLE 3
Example ASPS V-DMC extension syntax.

| | Descriptor |
|---|---|
| asps_vdmc_extension( ) { | |
| SubdivisionIterationCount | u(4) |
| LiftingQPs[0] | u(8) |
| LiftingQPs[1] | u(8) |
| LiftingQPs[2] | u(8) |
| InterpolateDisplacementNormals | u(1) |
| AddReconstructedNormals | u(1) |
| DisplacementReversePacking | u(1) |
| WidthDispVideo | u(16) |
| HeightDispVideo | u(16) |
| } | |

Table 4 illustrates an example of a syntax element used to code parameters in an atlas frame parameter set according to some embodiments.

TABLE 4
General atlas frame parameter set RBSP syntax.

| | | Descriptor |
|---|---|---|
| atlas_frame_parameter_set_rbsp( ) { | | |
| afps_atlas_frame_parameter_set_id | | ue(v) |
| afps_atlas_sequence_parameter_set_id | | ue(v) |
| atlas_frame_tile_information( ) | | |
| afps_output_flag_present_flag | | u(1) |
| afps_num_ref_idx_default_active_minus1 | | ue(v) |
| afps_additional_lt_afoc_lsb_len | | ue(v) |
| afps_lod_mode_enabled_flag | | u(1) |
| afps_extension_present_flag | | u(1) |
| if( afps_extension_present_flag ) { | | |
| afps_vpcc_extension_present_flag | † | u(1) |
| afps_miv_extension_present_flag | | u(1) |
| afps_vdmc_extension_present_flag | † | u(1) |
| afps_extension_5bits | † | u(5) |
| } | | |
| if( afps_vpcc_extension_present_flag ) | † | |
| afps_vpcc_extension( ) | † | |
| if( afps_miv_extension_present_flag ) | | |
| afps_miv_extension( ) /* Specified in ISO/IEC 23090-12 */ | | |
| if( afps_vdmc_extension_present_flag ) | † | |
| afps_vdmc_extension( ) | † | |
| if( afps_extension_5bits ) | † | |
| while( more_rbsp_data( ) ) | | |
| afps_extension_data_flag | | u(1) |
| rbsp_trailing_bits( ) | | |
| } | | |

Features marked with a dagger (t) are features that are added or revised in example embodiments as compared to the general atlas frame parameter set RBSP syntax (V3C Section 8.3.6.2.1).

As reflected in the syntax of Table 4, some methods include decoding second atlas type information from an atlas frame parameter set. In response to a determination that the second atlas type information identifies an atlas type associated with mesh-based coding, a second set of parameters for the atlas type associated with mesh-based coding is decoded from the atlas frame parameter set.

Different frame level atlas information may be useful in different 3D content coding content schemes such as V-PCC and V-DMC. To increase the flexibility of the atlas frame sequence parameter set, example embodiments of a 3D content specific extension syntax are described in Table 5 and Table 6. Any syntax elements within the afps_vpcc_extension( ) or afps_vdmc_extension( ) may be used to signal information which can be referred by NAL units of one or more coded atlas frame for point cloud or meshes respectively.

TABLE 5
AFPS V-PCC extension syntax.

| | Descriptor |
|---|---|
| afps_vpcc_extension( ) { | |
| afps_raw_3d_offset_bit_count_explicit_mode_flag | u(1) |
| } | |

As reflected in Table 5, in some embodiments, in response to the determination that the atlas type is associated with mesh-based coding, the following parameter is not coded in the sequence parameter set: afps_raw_3d_offset_bit_count_explicit_mode_flag.

TABLE 6
AFPS V-DMC extension syntax.

Descriptor

afps_vdmc_extension( ) {
}

Some embodiments use an atlas tile header syntax and/or an atlas tile data unit syntax according to previously known techniques.

In some embodiments, a V3C encoder/decoder may signal/decode the data specific to an V3C-based application type (i.e. V-PCC, MIV, V-DMC and etc.) based on the value of the ptl_profile_toolset_idc syntax element. Different values for ptl_profile_toolset_idc may be defined depending on the V3C-based application type. The value of ptl_profile_toolset_idc may be used to differentiate whether the V3C bitstream is a V-PCC, MIV, V-DMC or any other bitstream. The parameter ptl_profile_toolset_idc may be signaled in the V3C parameter set or through external means. The parameter indicates the application type and determine the constraints on V3C bitstream as well as atlas bitstream. When signaled in the V3C parameter set, “ptl_profile_toolset_idc” may be one of the parameters in the syntax structure “profile_tier_level( )”.

As an example, Table 7 provides syntax structure for Atlas Sequence Parameter Set with some syntax elements (indicated with a dagger, t) are constrained according to the values of ptl_profile_toolset_idc.

TABLE 7
Example of ASPS generalization with ptl_profile_toolset_idc

| | | Descriptor |
|---|---|---|
| atlas_sequence_parameter_set_rbsp( ) { | | |
| asps_atlas_sequence_parameter_set_id | | ue(v) |
| asps_frame_width | | ue(v) |
| asps_frame_height | | ue(v) |
| asps_geometry_3d_bit_depth_minus1 | | u(5) |
| asps_geometry_2d_bit_depth_minus1 | | u(5) |
| asps_log2_max_atlas_frame_order_cnt_lsb_minus4 | | ue(v) |
| asps_max_dec_atlas_frame_buffering_minus1 | | ue(v) |
| asps_long_term_ref_atlas_frames_flag | | u(1) |
| asps_num_ref_atlas_frame_lists_in_asps | | ue(v) |
| for( i = 0; i < asps_num_ref_atlas_frame_lists_in_asps; i++ ) | | |
| ref_list_struct( i ) | | |
| if( ptl_profile_toolset_idc == #PROFILE_TOOLSET_IDC for V-PCC/MIV ) { | † | |
| asps_use_eight_orientations_flag | † | u(1) |
| asps_extended_projection_enabled_flag | † | u(1) |
| if( asps_extended_projection_enabled_flag ) | † | |
| asps_max_number_projections_minus1 | † | ue(v) |
| asps_normal_axis_limits_quantization_enabled_flag | † | u(1) |
| asps_normal_axis_max_delta_value_enabled_flag | † | u(1) |
| asps_patch_precedence_order_flag | † | u(1) |
| asps_log2_patch_packing_block_size | † | u(3) |
| asps_patch_size_quantizer_present_flag | † | u(1) |
| asps_map_count_minus1 | † | u(4) |
| asps_pixel_deinterleaving_enabled_flag | † | u(1) |
| if( asps_pixel_deinterleaving_enabled_flag ) | † | |
| for( j = 0; j <= asps_map_count_minus1; j++ ) | † | |
| asps_map_pixel_deinterleaving_flag[ j ] | † | u(1) |
| asps_raw_patch_enabled_flag | † | u(1) |
| asps_eom_patch_enabled_flag | † | u(1) |
| if( asps_eom_patch_enabled_flag && asps_map_count_minus1 == 0 ) | † | |
| asps_eom_fix_bit_count_minus1 | † | u(4) |
| if( asps_raw_patch_enabled_flag ∥ asps_eom_patch_enabled_flag ) | † | |
| asps_auxiliary_video_enabled_flag | † | u(1) |
| asps_plr_enabled_flag | † | u(1) |
| if( asps_plr_enabled_flag ) | † | |
| asps_plr_information( asps_map_count_minus1 ) | † | |
| } else if ( ptl_profile_toolset_idc == #VDMC TOOLSET IDC) { | † | |
| VDMC-SPECIFIC ASPS SYNTAX ELEMENTS | † | |
| } | † | |
| asps_vui_parameters_present_flag | | u(1) |
| if( asps_vui_parameters_present_flag ) | | |
| vui_parameters( ) | | |
| asps_extension_present_flag | | u(1) |
| if( asps_extension_present_flag ) { | | |
| asps_vpcc_extension_present_flag | | u(1) |
| asps_miv_extension_present_flag | | u(1) |
| asps_extension_6bits | | u(1) |
| } | | |
| if( asps_vpcc_extension_present_flag ) | | |
| asps_vpcc_extension( ) /* Specified in Annex H */ | | |
| if( asps_miv_extension_present_flag ) | | |
| asps_miv_extension( ) /* Specified in ISO/IEC 23090-12 */ | | |
| if( asps_extension_6bits ) | | |
| while( more_rbsp_data( ) ) | | |
| asps_extension_data_flag | | u(1) |
| rbsp_trailing_bits( ) | | |
| } | | |

As reflected in Table 7, a mesh decoding method according to some embodiments includes: decoding mesh-based 3D volumetric coding data, wherein decoding the mesh-based 3D volumetric coding data comprises decoding an atlas for the mesh-based 3D volumetric coding. Decoding the atlas includes decoding first atlas type information from a sequence parameter set of the atlas. In response to a determination that the first atlas type information identifies an atlas type associated with mesh-based coding, a first set of parameters is decoded from the sequence parameter set for the atlas type associated with mesh-based coding.

In some such embodiments, the first atlas type information includes an atlas type parameter, the parameter having a value indicating that the atlas type is associated with mesh-based coding.

In some embodiments, in addition to the atlas sequence parameter set, a V3C encoder/decoder may signal/decode an Atlas Frame Parameter Set which is constrained by the syntax element ptl_profile_toolset_idc. The syntax elements under the constraint will be applicable for a particular value of the ptl_profile_toolset_idc. As an example, Table 8 provides syntax structure for Atlas Frame Parameter Set with some syntax elements (indicated with a dagger, t) contained according to the values of ptl_profile_toolset_idc for a V3C-based application (i.e. V-PCC, V-DMC, MIV, or etc.).

TABLE 8
General atlas frame parameter set RBSP syntax.

| | | Descriptor |
|---|---|---|
| atlas_frame_parameter_set_rbsp( ) { | | |
| afps_atlas_frame_parameter_set_id | | ue(v) |
| afps_atlas_sequence_parameter_set_id | | ue(v) |
| atlas_frame_tile_information( ) | | |
| afps_output_flag_present_flag | | u(1) |
| afps_num_ref_idx_default_active_minus1 | | ue(v) |
| afps_additional_lt_afoc_lsb_len | | ue(v) |
| afps_lod_mode_enabled_flag | | u(1) |
| if( ptl_profile_toolset_idc == #PROFILE_TOOLSET_IDC for V-PCC/) { | † | |
| afps_raw_3d_offset_bit_count_explicit_mode_flag | † | u(1) |
| } else if (ptl_profile_toolset_idc == #PROFILE_TOOLSET_IDC for V-DMC) { | † | |
| ... | | |
| } | | |
| afps_extension_present_flag | | u(1) |
| if( afps_extension_present_flag ) { | | |
| afps_miv_extension_present_flag | | u(1) |
| afps_extension_7bits | | u(7) |
| } | | |
| if( afps_miv_extension present_flag ) | | |
| afps_miv_extension( ) /* Specified in ISO/IEC 23090-12 */ | | |
| if( afps_extension_7bits ) | | |
| while( more_rbsp_data( ) ) | | |
| afps_extension_data_flag | | u(1) |
| rbsp_trailing_bits( ) | | |
| } | | |

As reflected in Table 8, in some embodiments, the first atlas type information includes an atlas type parameter, the parameter having a value indicating that the atlas type is associated with mesh-based coding. In response to a determination that the first atlas type information identifies an atlas type associated with mesh-based coding, a second set of parameters for the atlas type associated with mesh-based coding is decoded from an atlas frame parameter set.

Some systems and methods as described herein further include a parameter in an atlas video parameter set to indicate the type of data stored in the current bitstream and consequently in the atlas. For example, some implementations may add a parameter in the V3C VPS data, defined in “8.3.4.1 General V3C parameter set syntax”, to indicate the type of data.

In some embodiments, the parameter used in the atlas video parameter set to indicate the type of data stored in the current bitstream may be a parameter v3c_type in a V3C VPS. In some embodiments, the parameter v3c_type may have one the following values:
VPCC_TYPE=0: corresponding V-PCC bitstream
MIV_TYPE=1: corresponding MIV bitstream
VDMC_TYPE=2: corresponding V-DMC bitstream

In some embodiments, additional values may be assigned to other types of bitstreams.

In some embodiments, this parameters, such as a v3c_type parameter, is provided as part of the VPS as shown in Table 7.

TABLE 9
Example V3C parameter set syntax.

| | | Descriptor |
|---|---|---|
| v3c_parameter_set( numBytesInV3CPayload ) { | | |
| profile_tier_level( ) | | |
| vps_v3c_parameter_set_id | | u(4) |
| vps_reserved_zero_8bits | | u(8) |
| vps_codec_type | † | u(2) \| ue(v) |
| vps_atlas_count_minus1 | | u(6) |
| for( k = 0; k < vps_atlas_count_minus1 + 1; k++ ) { | | |
| vps_atlas_id[ k ] | | u(6) |
| j = vps_atlas_id[ k ] | | |
| vps_frame_width[ j ] | | ue(v) |
| vps_frame_height[ j ] | | ue(v) |
| vps_map_count_minus1[ j ] | | u(4) |
| if( vps_map_count_minus1 [ j ] > 0 ) | | |
| vps_multiple_map_streams_present_flag[ j ] | | u(1) |
| vps_map_absolute_coding_enabled_flag[ j ][ 0 ] = 1 | | |
| vps_map_predictor_index_diff[ j ][ 0 ] = 0 | | |
| for( i = 1; i <= vps_map_count_minus1[ j ]; i++ ) { | | |
| if( vps_multiple_map_streams_present_flag[ j ] ) | | |
| vps_map_absolute_coding_enabled_flag[ j ][ i ] | | u(1) |
| else | | |
| vps_map_absolute_coding_enabled_flag[ j ][ i ] = 1 | | |
| if( vps_map_absolute_coding_enabled_flag[ j ][ i ] == 0 ) { | | |
| vps_map_predictor_index_diff[ j ][ i ] | | ue(v) |
| } | | |
| } | | |
| vps_auxiliary_video_present_flag[ j ] | | u(1) |
| vps_occupancy_video_present_flag[ j ] | | u(1) |
| vps_geometry_video_present_flag[ j ] | | u(1) |
| vps_attribute_video_present_flag[ j ] | | u(1) |
| if( vps_occupancy_video_present_flag[ j ] ) | | |
| occupancy_information( j ) | | |
| if( vps_geometry_video_present_flag[ j ] ) | | |
| geometry_information( j ) | | |
| if( vps_attribute_video_present_flag[ j ] ) | | |
| attribute_information( j ) | | |
| } | | |
| vps_extension_present_flag | | u(1) |
| if( vps_extension_present_flag ) { | | |
| vps_extension_count | | u(8) |
| } | | |
| if( vps_extension_count ) { | | |
| vps_extensions_length_minus1 | | ue(v) |
| for( i = 0; i < vps_extension_count; i++ ) { | | |
| vps_extension_type[ i ] | | u(8) |
| vps_extension_length[ i ] | | u(16) |
| vps_extension( vps_extension_type[ i ], vps_extension_length[ i ] ) | | |
| } | | |
| } | | |
| byte_alignment( ) | | |
| } | | |

Features marked with a dagger (t) are features that are added or revised in example embodiments as compared to the general V3C parameter set syntax (section 8.3.4.1).

In some embodiments, rather than using a single parameter such as the example v3c_type parameter shown above, the type of the bitstream carried by the V3C bitstream may be coded using an individual flag for each bitstream type, such as the following three flags:
vpc_vpcc_flag
vps_miv_flag
vdmc_vdmc_flag

Example embodiments that use a v3c_type parameter or a flag as shown above may not be backward compatible with some existing bitstreams. Some example embodiments provide for backward compatibility with at least some existing bitstream syntaxes. In one such embodiment, an existing parameter such as the parameter vps_reserved_zero_8 bits is used to code the type. In this case backward compatibility may be maintained. For example, if the parameter vps_reserved_zero_8 bits is zero, then a conventional bitstream structure may be used, while non-zero values may be used to indicate other video parameter set types, and the bitstream syntax may be adjusted accordingly.

Some alternative embodiments maintain backward compatibility by providing an extension that allows for looping over the atlases and defining for each of those what kind of data is conveyed. MPEG immersive video (MIV), which was built on top of the V-PCC specification, has already defined a VPS extension that enables MIV data to be conveyed while not broking the backward compatibility with V-PCC.

In some embodiments, information provided at the V3C bitstream level (from the VPS) of the type of the data stored in the atlas enables conditional enabling or disabling of the inclusion of syntax elements at lower levels in the bitstream. For example, the presence or absence of some syntax elements may be conditioned on whether the bitstream is based on, e.g., V-PCC, MIV, V-DMC, or other future data. For instance, some parameters may be present in or absent from syntax elements such as atlas_tile_data_header and/or atlas_tile_data_unit syntaxes. As shown in Table 8, a substantial amount of information can be omitted by excluding parameters that are related only to codec type that is not being used. For example, several parameters may be omitted when V-PCC is not being used. Thus, including such data depending on the kind of data:

TABLE 10
Atlas tile header syntax (Section 8.3.6.11)

| | | Descriptor |
|---|---|---|
| atlas_tile_header( ) { | | |
| if( nal_unit_type >= NAL_BLA_W_LP && nal_unit_type <= NAL_RSV_IRAP_ACL_29) | | |
| ath_no_output_of_prior_atlas_frames_flag | | u(1) |
| ath_atlas_frame_parameter_set_id | | ue(v) |
| ath_atlas_adaptation_parameter_set_id | | ue(v) |
| ath_id | | u(v) |
| ath_type | | ue(v) |
| if( afps_output_flag_present_flag ) | | |
| ath_atlas_output_flag | | u(1) |
| ath_atlas_frm_order_cnt_lsb | | u(v) |
| if( asps_num_ref_atlas_frame_lists_in_asps > 0 ) | | |
| ath_ref_atlas_frame_list_asps_flag | | u(1) |
| if( ath_ref_atlas_frame_list_asps_flag == 0 ) | | |
| ref_list_struct( asps_num_ref_atlas_frame_lists_in_asps ) | | |
| else if( asps_num_ref_atlas_frame_lists_in_asps > 1 ) | | |
| ath_ref_atlas_frame_list_idx | | u(v) |
| for( j = 0; j < NumLtrAtlasFrmEntries[ RlsIdx ]; j++ ) { | | |
| ath_additional_afoc_lsb_present_flag[ j ] | | u(1) |
| if( ath_additional_afoc_lsb_present_flag[ j ] ) | | |
| ath_additional_afoc_lsb_val[ j ] | | u(v) |
| } | | |
| if( ath_type != SKIP_TILE ) { | | |
| if( vps_codec_type == VPCC_TYPE ) { | † | |
| if( asps_normal_axis_limits_quantization_enabled_flag ) { | | |
| ath_pos_min_d_quantizer | | u(5) |
| if( asps_normal_axis_max_delta_value_enabled_flag ) | | |
| ath_pos_delta_max_d_quantizer | | u(5) |
| } | | |
| if( asps_patch_size_quantizer_present_flag ) { | | |
| ath_patch_size_x_info_quantizer | | u(3) |
| ath_patch_size_y_info_quantizer | | u(3) |
| } | | |
| if( afps_raw_3d_offset_bit_count_explicit_mode_flag ) | | |
| ath_raw_3d_offset_axis_bit_count_minus1 | | u(v) |
| } | † | |
| if( ath_type == P_TILE && num_ref_entries[ RlsIdx ] > 1 ) { | | |
| ath_num_ref_idx_active_override_flag | | u(1) |
| if( ath_num_ref_idx_active_override_flag ) | | |
| ath_num_ref_idx_active_minus1 | | ue(v) |
| } | | |
| } | | |
| byte_alignment( ) | | |
| } | | |

Features marked with a dagger (t) are features that are added or revised in example embodiments as compared to the V3C atlas tile header syntax (section 8.3.6.11).

As reflected in Table 10, in some embodiments, third atlas type information is decoded from a video parameter set. In response to a determination that the third atlas type information does not indicate an atlas type associated with point cloud coding, at least one of the following parameters is not coded in an atlas tile header: ath_pos_min_d_quantizer, ath_pos_delta_max_d_quantizer, ath_patch_size_x_info_quantizer, ath_patch_size_y_info_quantizer, or ath_raw_3d_offset_axis_bit_count_minus1.

TABLE 11
General atlas tile data unit syntax.

| | | Descriptor |
|---|---|---|
| atlas_tile_data_unit( tileID ) { | | |
| if( ath_type == SKIP_TILE ) { | | |
| for( p = 0; p < RefAtduTotalNumPatches[ tileID ]; p++ ) | | |
| skip_patch_data_unit( ) | | |
| } else { | | |
| p = 0 | | |
| do { | | |
| atdu_patch_mode[ tileID ][ p ] | | ue(v) |
| isEnd = ( ath_type == P_TILE && atdu_patch_mode[ tileID ][ p ] == P_END) ∥ | | |
| ( ath_type == I_TILE && atdu_patch_mode[ tileID ][ p ] == I_END ) | | |
| if( !isEnd ) { | | |
| if( vps_codec_type == VPCC_TYPE ) | † | |
| patch_vpcc_information_data( tileID , p , atdu_patch_mode[ tileID ][ p ] ) | | |
| if( vps_codec_type == VDMC_TYPE ) { | † | |
| patch_vdmc_information_data( tileID , p , atdu_patch_mode[ tileID ][ p ] ) | † | |
| p++ | | |
| } | | |
| } while( !isEnd ) | | |
| } | | |
| AtduTotalNumPatches[ tileID ] = p | | |
| } | | |

Features marked with a dagger (t) are features that are added or revised in example embodiments as compared to the V3C atlas tile data unit syntax (section 8.3.7.1).

As reflected in Table 11, some embodiments include decoding third atlas type information from a video parameter set. In response to a determination that the third atlas type information indicates an atlas type associated with mesh-based coding, mesh-based patch information is decoded from an atlas tile data unit.

In some embodiments, the default value for vps_codec_type may be assigned to (VPCC_TYPE) when not present at the VPS level, which would enable to maintain the backward compatibility with the current V3C standard.

Some embodiments may make use of application-based atlas tile data. In some embodiments, the value of ptl_profile_toolset_idc may be used to determine the type of patch/atlas tile data unit within the V3C bitstream. Having information indicating the values of ptl_profile_toolset_idc, a V3C decoder may infer the type of atlas tile data or patches contained within the V3C bitstream. Such a scenario may involve a syntax structure as shown in Table 12. A V3C encoder may signal application-specific atlas tile data depending on the value of ptl_profile_toolset_idc reserved for the particular application (i.e. V-PCC, MIV, V-DMC, etc.). Since the syntax element ptl_profile_toolset_idc is available in the Atlas sequence parameter set, the value of the syntax element may be used to infer the type of atlas tile data unit.

TABLE 12
Modified Atalas tile layer RBSP syntax structure with constrained
based on ptl_profile_toolset_idc

| | | Descriptor |
|---|---|---|
| atlas_tile_layer_rbsp( ) { | | |
| atlas_tile_header( ) | | |
| if( ptl_profile_toolset_idc == #PROFILE_TOOLSET_IDC for V-PCC/) { | | |
| Atlas_tile_data_unit(ath_id) /* Specified in ISO/IEC 23090-5 and/or ISO/IEC | | u(1) |
| 23090-12 | † | |
| } else if (ptl_profile_toolset_idc == #PROFILE_TOOLSET_IDC for V-DMC) { | † | |
| vdmc_atlas_tile_Data_unit(ath_id) /* Specified in ISO/IEC 23090-29 */ | † | |
| } | | |
| atlas_tile_data_unit( ath_id ) | † | |
| rbsp_trailing_bits( ) | | |
| } | | |

In some embodiments, the syntax element ptl_profile_toolset_idc may be used to infer the type of patch within an atlas tile as shown in Table 13. A V3C encoder/decoder may signal/decode patch data which is specific to a particular application which is determined by the value of the syntax element ptl_profile_toolset_idc.

TABLE 13
General atlas tile data unit syntax

| | | Descriptor |
|---|---|---|
| atlas_tile_data_unit( tileID ) { | | |
| if( ath_type == SKIP_TILE ) { | | |
| for( p = 0; p < RefAtduTotalNumPatches[ tileID ]; p++ ) | | |
| skip_patch_data_unit( ) | | |
| } else { | | |
| p = 0 | | |
| do { | | |
| atdu_patch_mode[ tileID ][ p ] | | ue(v) |
| isEnd = ( ath_type == P_TILE && atdu_patch_mode[ tileID ][ p ] == P_END) ∥ | | |
| ( ath_type == I_TILE && atdu_patch_mode[ tileID ][ p ] == I_END ) | | |
| if( !isEnd ) { | | |
| if( ptl_profile_toolset_idc == #PROFILE TOOLSET IDC VALUE FOR V-PCC ) { | † | |
| patch_vpcc_information_data( tileID , p , atdu_patch_mode[ tileID ][ p ] ) | | |
| Else if(ptl_profile_toolset_idc == #PROFILE TOOLSET IDC VALUE FOR V-DMC ) { | † | |
| patch_vdmc_information_data( tileID , p , atdu_patch_mode[ tileID ][ p ] ) | † | |
| Else if(ptl_profile_toolset_idc == #PROFILE TOOLSET IDC VALUE FOR MIV ) { | † | |
| patch_miv_information_data( tileID , p , atdu_patch_mode[ tileID ][ p ] ) | † | |
| Else if(ptl_profile_toolset_idc == #PROFILE TOOLSET IDC VALUE FOR OTHER | | |
| APPLICATIONS ) { | † | |
| Patch_OTHER_APPLICATION_information_data( tileID , p , atdu_patch_mode[ tileID ][ p ] ) | † | |
| p++ | | |
| } | | |
| } while( !isEnd ) | | |
| } | | |
| AtduTotalNumPatches[ tileID ] = p | | |
| } | | |

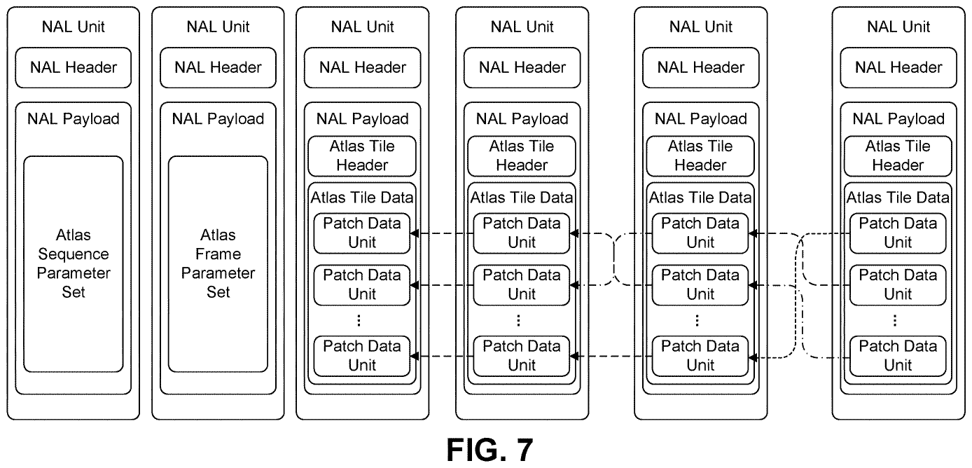

In some embodiments, atlas tile data is encapsulated in network abstraction layer (NAL) units. An example atlas NAL structure is illustrated in FIG. 7 and described in, for example, Lauri Ilola et al., “An Overview of the MPEG Standard for Storage and Transport of Visual Volumetric Video-Based Coding,” Front. Signal Process., vol. 2, 29 Apr. 2022. Each atlas tile is contained within a NAL unit. Each NAL unit in an atlas sub-bitstream is assigned a NAL unit type. In example embodiments, the atlas tile type is deduced from the NAL unit it is contained within. For example, Table 15 illustrates an example relationship between atlas tile type and NAL unit type. Example embodiments make use of this relationship to determine the type of atlas from the NAL unit type rather than signaling the type of the atlas tile in the bitstream.

Some such embodiments do not signal the atlas tile header type parameter (e.g. ath_type) in the atlas tile header (e.g. atlas_tile_header). Instead, in some embodiments, a value corresponding to this header type parameter is derived from the NAL unit type, e.g. from the parameter nal_unit_type stored in nal_unit_header. Such embodiments allow a reduction in the size of the atlas tile header syntax. In an example embodiment, the updated atlas_type_header syntax is as shown in Table 14.

TABLE 14
Updated atlas tile header syntax

| | | Descriptor |
|---|---|---|
| atlas_tile_header( ) { | | |
| if( nal_unit_type >= NAL_BLA_W_LP && nal_unit_type <= NAL_RSV_IRAP_ACL_29 ) | | |
| ath_no_output_of_prior_atlas_frames_flag | | u(1) |
| ath_atlas_frame_parameter_set_id | | ue(v) |
| ath_atlas_adaptation_parameter_set_id | | ue(v) |
| ath_id | | u(v) |
| ath_type = deriveAthType(nal_unit_type) | † | |
| if( afps_output_flag_present_flag ) | | |
| ath_atlas_output_flag | | u(1) |
| ... | | ... |
| byte_alignment( ) | | |
| } | | |

The feature marked with a dagger (t) is revised in example embodiments as compared to the V3C atlas tile header syntax (section 8.3.6.11).

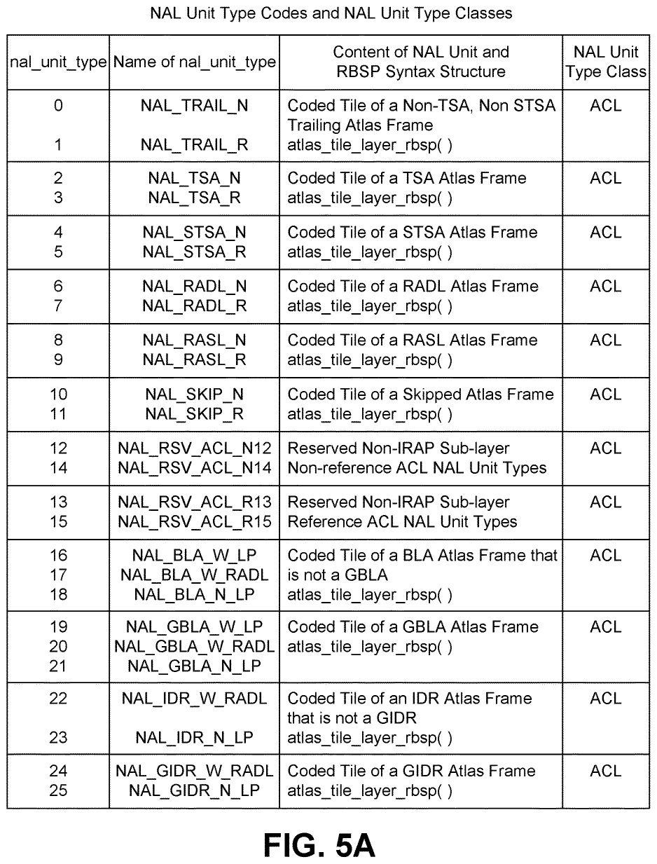

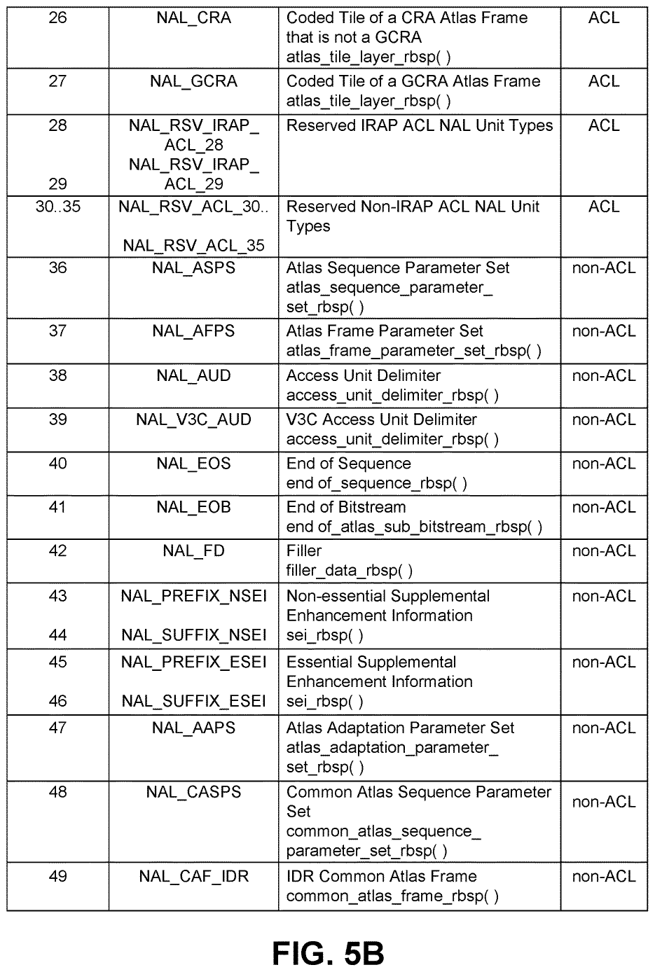

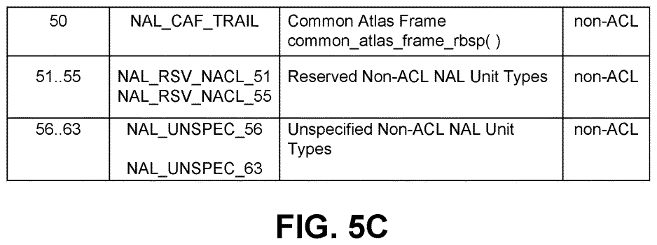

In some such embodiments, the ath_type information is derived from the nal_unit_type stored in nal_unit_header without requiring any extra information from the bitstream. FIGS. 5A-5B illustrate an example relationship between the nal_unit_type parameter and the corresponding semantics as used in V3C.

Table 15 illustrates an example of how the first 36 types that define atlas coding layer type (ACL) are derived to set the ath_type. Specifically, the table shows an example of a way to derive the ath_type from the nal_unit_type.

TABLE 15
Derive ath_type based on nal_unit_type.

| nal_unit_type | Name of nal_unit_type | Derived ath_type |
|---|---|---|
| 0 | NAL_TRAIL_N | P_TILE |
| 1 | NAL_TRAIL_R | |
| 2 | NAL_TSA_N | P_TILE |
| 3 | NAL_TSA_R | |
| 4 | NAL_STSA_N | P_TILE |
| 5 | NAL_STSA_R | |
| 6 | NAL_RADL_N | P_TILE |
| 7 | NAL_RADL_R | |
| 8 | NAL_RASL_N | P_TILE |
| 9 | NAL_RASL_R | |
| 10 | NAL_SKIP_N | SKIP_TILE |
| 11 | NAL_SKIP_R | |
| 12 | NAL_RSV_ACL_N12 | P_TILE |
| 14 | NAL_RSV_ACL_N14 | |
| 13 | NAL_RSV_ACL_R13 | P_TILE |
| 15 | NAL_RSV_ACL_R15 | |
| 16 | NAL_BLA_W_LP | I_TILE |
| 17 | NAL_BLA_W_RADL | |
| 18 | NAL_BLA_N_LP | |
| 19 | NAL_GBLA_W_LP | I_TILE |
| 20 | NAL_GBLA_W_RADL | |
| 21 | NAL_GBLA_N_LP | |
| 22 | NAL_IDR_W_RADL | I_TILE |
| 23 | NAL_IDR_N_LP | |
| 24 | NAL_GIDR_W_RADL | I_TILE |
| 25 | NAL_GIDR_N_LP | |
| 26 | NAL_CRA | I_TILE |
| 27 | NAL_GCRA | I_TILE |
| 28 | NAL_RSV_IRAP_ACL_28 | I_TILE |
| 29 | NAL_RSV_IRAP_ACL_29 | |
| 30 . . . 35 | NAL_RSV_ACL_30 . . . | P_TILE |
| | NAL_RSV_ACL_35 | |

In some embodiments, the derivation of the atlas type from the NAL unity type is performed using a method as illustrated in the following source code:

```
PCCTileType deriveAthType( NalUnitType nalUnitType ){
  PCCTileType athType = I_TILE;
  switch (nalUnitType) {
```

| | | | |
|---|---|---|---|
| case | NAL_TRAIL_N: | athType = P_TILE; | break; |
| case | NAL_TRAIL_R: | athType = P_TILE; | break; |
| case | NAL_TSA_N: | athType = P_TILE; | break; |
| case | NAL_TSA_R: | athType = P_TILE; | break; |
| case | NAL_STSA_N: | athType = P_TILE; | break; |
| case | NAL_STSA_R: | athType = P_TILE; | break; |
| case | NAL_RADL_N: | athType = P_TILE; | break; |
| case | NAL_RADL_R: | athType = P_TILE; | break; |
| case | NAL_RASL_N: | athType = P_TILE; | break; |
| case | NAL_RASL_R: | athType = P_TILE; | break; |
| case | NAL_SKIP_N: | athType = SKIP_TILE; | break; |
| case | NAL_SKIP_R: | athType = SKIP_TILE; | break; |
| case | NAL_RSV_ACL_N12: | athType = P_TILE; | break; |
| case | NAL_RSV_ACL_N14: | athType = P_TILE; | break; |
| case | NAL_RSV_ACL_R13: | athType = P_TILE; | break; |
| case | NAL_RSV_ACL_R15: | athType = P_TILE; | break; |
| case | NAL_BLA_W_LP: | athType = I_TILE; | break; |
| case | NAL_BLA_W_RADL: | athType = I_TILE; | break; |
| case | NAL_BLA_N_LP: | athType = I_TILE; | break; |
| case | NAL_GBLA_W_LP: | athType = I_TILE; | break; |
| case | NAL_GBLA_W_RADL: | athType = I_TILE; | break; |
| case | NAL_GBLA_N_LP: | athType = I_TILE; | break; |
| case | NAL_IDR_W_RADL: | athType = I_TILE; | break; |
| case | NAL_IDR_N_LP: | athType = I_TILE; | break; |
| case | NAL_GIDR_W_RADL: | athType = I_TILE; | break; |
| case | NAL_GIDR_N_LP: | athType = I_TILE; | break; |
| case | NAL_CRA: | athType = I_TILE; | break; |
| case | NAL_GCRA: | athType = I_TILE; | break; |
| case | NAL_RSV_IRAP_ACL_28: | athType = P_TILE; | break; |
| case | NAL_RSV_IRAP_ACL_29: | athType = P_TILE; | break; |
| case | NAL_RSV_ACL_30: | athType = P_TILE; | break; |
| case | NAL_RSV_ACL_31: | athType = P_TILE; | break; |
| case | NAL_RSV_ACL_32: | athType = P_TILE; | break; |
| case | NAL_RSV_ACL_33: | athType = P_TILE; | break; |
| case | NAL_RSV_ACL_34: | athType = P_TILE; | break; |
| case | NAL_RSV_ACL_35: | athType = P_TILE; | break; |

| | | |
|---|---|---|
| default: | athType = P_TILE; | break; |

```
  }
  return athType;
}
```

The current atlas raw byte sequence payload (RBSP) of V3C is defined in section “8.3.6 Raw byte sequence payloads, trailing bits, and byte alignment syntax” and section “8.3.7 Atlas tile data unit syntax” of ISO/IEC FDIS 23090-5 2nd Edition Visual volumetric video-based coding (V3C) and video-based point cloud compression (V-PCC), ISO/IEC JTC 1/SC 29/WG 7, 23090-5: 2023 (E), MDS22483_WG07_N00553, MDS22483, January 2023. In particular, these sections describe the syntax of:
Atlas sequence parameter set RBSP syntax (8.3.6.1)
Atlas frame parameter set RBSP syntax (8.3.6.2)
Atlas tile header syntax (8.3.6.11)
General atlas tile data unit syntax (8.3.7.1)

These subsections describe the Atlas syntax that is used to carry V-PCC and MIV data. However, much of the stored data would not be used if a V3C bitstream were used to describe another type of data, such as V-DMC data, in the altas.

The tables below show these syntax tables. An asterisk (*) is provided to indicate data used by V-PCC but not by other codecs. In some embodiments, the signaling of some or all of that data is conditioned on the type of codec used to code the volumetric data, using techniques as described above.

TABLE 16
General atlas sequence parameter set RBSP syntax (Section 8.3.6.1.1)

| | | Descriptor |
|---|---|---|
| atlas_sequence_parameter_set_rbsp( ) { | | |
| asps_atlas_sequence_parameter_set_id | | ue(v) |
| asps_frame_width | | ue(v) |
| asps_frame_height | | ue(v) |
| asps_geometry_3d_bit_depth_minus1 | | u(5) |
| asps_geometry_2d_bit_depth_minus1 | | u(5) |
| asps_log2_max_atlas_frame_order_cnt_lsb_minus4 | | ue(v) |
| asps_max_dec_atlas_frame_buffering_minus1 | | ue(v) |
| asps_long_term_ref_atlas_frames_flag | | u(1) |
| asps_num_ref_atlas_frame_lists_in_asps | | ue(v) |
| for( i = 0; i < asps_num_ref_atlas_frame_lists_in_asps; i++ ) | | |
| ref_list_struct( i ) | | |
| asps_use_eight_orientations_flag | * | u(1) |
| asps_extended_projection_enabled_flag | * | u(1) |
| if( asps_extended_projection_enabled_flag ) | * | |
| asps_max_number_projections_minus1 | * | ue(v) |
| asps_normal_axis_limits_quantization_enabled_flag | * | u(1) |
| asps_normal_axis_max_delta_value_enabled_flag | * | u(1) |
| asps_patch_precedence_order_flag | * | u(1) |
| asps_log2_patch_packing_block_size | * | u(3) |
| asps_patch_size_quantizer_present_flag | * | u(1) |
| asps_map_count_minus1 | * | u(4) |
| asps_pixel_deinterleaving_enabled_flag | * | u(1) |
| if( asps_pixel_deinterleaving_enabled_flag ) | * | |
| for( j = 0; j <= asps_map_count_minus1; j++ ) | * | |
| asps_map_pixel_deinterleaving_flag[ j ] | * | u(1) |
| asps_raw_patch_enabled_flag | * | u(1) |
| asps_eom_patch_enabled_flag | * | u(1) |
| if( asps_eom_patch_enabled_flag && asps_map_count_minus1 == 0 ) | * | |
| asps_eom_fix_bit_count_minus1 | * | u(4) |
| if( asps_raw_patch_enabled_flag \|\| asps_eom_patch_enabled_flag ) | * | |
| asps_auxiliary_video_enabled_flag | * | u(1) |
| asps_plr_enabled_flag | * | u(1) |
| if( asps_plr_enabled_flag ) | * | |
| asps_plr_information( asps_map_count_minus1 ) | * | |

| | |
|---|---|
| asps_vui_parameters_present_flag | u(1) |
| if( asps_vui_parameters_present_flag ) | |
| vui_parameters( ) | |
| asps_extension_present_flag | u(1) |
| if( asps_extension_present_flag ) { | |
| asps_vpcc_extension_present_flag | u(1) |
| asps_miv_extension_present_flag | u(1) |
| asps_extension_6bits | u(6) |
| } | |
| if( asps_vpcc_extension_present_flag ) | |
| asps_vpcc_extension( ) /* Specified in Annex H */ | |
| if( asps_miv_extension_present_flag ) | |
| asps_miv_extension( ) /* Specified in ISO/IEC 23090-12 */ | |
| if( asps_extension_6bits ) | |
| while( more_rbsp_data( ) ) | |
| asps_extension_data_flag | u(1) |
| rbsp_trailing_bits( ) | |
| } | |

TABLE 17
General atlas frame parameter set RBSP syntax (Section 8.3.6.2.1)

| | | Descriptor |
|---|---|---|
| atlas_frame_parameter_set_rbsp( ) { | | |
| afps_atlas_frame_parameter_set_id | | ue(v) |
| afps_atlas_sequence_parameter_set_id | | ue(v) |
| atlas_frame_tile_information( ) | * | |
| afps_output_flag_present_flag | | u(1) |
| afps_num_ref_idx_default_active_minus1 | | ue(v) |
| afps_additional_lt_afoc_lsb_len | | ue(v) |
| afps_lod_mode_enabled_flag | | u(1) |
| afps_raw_3d_offset_bit_count_explicit_mode_flag | * | u(1) |

| | |
|---|---|
| afps_extension_present_flag | u(1) |
| if( afps_extension_present_flag ) { | |
| afps_miv_extension_present_flag | u(1) |
| afps_extension_7bits | u(7) |
| } | |
| if( afps_miv_extension_present_flag ) | |
| afps_miv_extension( ) /* Specified in ISO/IEC 23090-12 */ | |
| if( afps_extension_7bits ) | |
| while( more_rbsp_data( ) ) | |
| afps_extension_data_flag | u(1) |
| rbsp_trailing_bits( ) | |
| } | |

TABLE 18
Atlas tile header syntax (Section 8.3.6.11)

| | | Descriptor |
|---|---|---|
| atlas_tile_header( ) { | | |
| if( nal_unit_type >= NAL_BLA_W_LP && nal_unit_type <= NAL_RSV_IRAP_ACL_29 ) | | |
| ath_no_output_of_prior_atlas_frames_flag | | u(1) |
| ath_atlas_frame_parameter_set_id | | ue(v) |
| ath_atlas_adaptation_parameter_set_id | | ue(v) |
| ath_id | | u(v) |
| ath_type | | ue(v) |
| if( afps_output_flag_present_flag ) | | |
| ath_atlas_output_flag | | u(1) |
| ath_atlas_frm_order_cnt_lsb | | u(v) |
| if( asps_num_ref_atlas_frame_lists_in_asps > 0 ) | | |
| ath_ref_atlas_frame_list_asps_flag | | u(1) |
| if( ath_ref_atlas_frame_list_asps_flag == 0 ) | | |
| ref_list_struct( asps_num_ref_atlas_frame_lists_in_asps ) | | |
| else if( asps_num_ref_atlas_frame_lists_in_asps > 1 ) | | |
| ath_ref_atlas_frame_list_idx | | u(v) |
| for( j = 0; j < NumLtrAtlasFrmEntries[ RlsIdx ]; j++ ) { | | |
| ath_additional_afoc_lsb_present_flag[ j ] | | u(1) |
| if( ath_additional_afoc_lsb_present_flag[ j ] ) | | |
| ath_additional_afoc_lsb_val[ j ] | | u(v) |
| } | | |
| if( ath_type != SKIP_TILE ) { | | |
| if( asps_normal_axis_limits_quantization_enabled_flag ) { | * | |
| ath_pos_min_d_quantizer | * | u(5) |
| if( asps_normal_axis_max_delta_value_enabled_flag ) | * | |
| ath_pos_delta_max_d_quantizer | * | u(5) |
| } | * | |
| if( asps_patch_size_quantizer_present_flag ) { | * | |
| ath_patch_size_x_info_quantizer | * | u(3) |
| ath_patch_size_y_info_quantizer | * | u(3) |
| } | * | |
| if( afps_raw_3d_offset_bit_count_explicit_mode_flag ) | * | |
| ath_raw_3d_offset_axis_bit_count_minus1 | * | u(v) |

| | |
|---|---|
| if( ath_type == P_TILE && num_ref_entries[ RlsIdx ] > 1 ) { | |
| ath_num_ref_idx_active_override_flag | u(1) |
| if( ath_num_ref_idx_active_override_flag ) | |
| ath_num_ref_idx_active_minus1 | ue(v) |
| } | |
| } | |
| byte_alignment( ) | |
| } | |

TABLE 19
General atlas tile data unit syntax (Section 8.3.7.1)

| | Descriptor |
|---|---|
| atlas_tile_data_unit( tileID ) { | |
| if( ath_type == SKIP_TILE ) { | |
| for( p = 0; p < RefAtduTotalNumPatches[ tileID ]; p++ ) | |
| skip_patch_data_unit( ) | |
| } else { | |
| p = 0 | |
| do { | |
| atdu_patch_mode[ tileID ][ p ] | ue(v) |
| isEnd = ( ath_type == P_TILE && atdu_patch_mode[ tileID ][ p ] == P_END) \|\| | |
| ( ath_type == I_TILE && atdu_patch_mode[ tileID ][ p ] == I_END ) | |
| if( !isEnd ) { | |
| patch_information_data( tileID , p , atdu_patch_mode[ tileID ][ p ] ) * | |
| p++ | |
| } | |
| } while( !isEnd ) | |
| } | |
| AtduTotalNumPatches[ tileID ] = p | |
| } | |

All the data marked with an asterisk (*) in the four previous tables are used to store V-PCC data that is not used by V-DMC decoder.

The following table illustrates a syntax function used to parse an atlas sample stream.

TABLE 20
Sample stream NAL unit syntax (section D.2.2)

| | Descriptor |
|---|---|
| sample_stream_nal_unit( ) { | |
| ssnu_nal_unit_size | u(v) |
| nal_unit(ssnu_nal_unit_size ) | |
| } | |

TABLE 21
General NAL unit syntax (section 8.3.5.1)

| | Descriptor |
|---|---|
| nal_unit( NumBytesInNalUnit ) { | |
| nal_unit_header( ) | |
| NumBytesInRbsp = 0 | |
| for( i = 2; i < NumBytesInNalUnit; i++ ) | |
| rbsp_byte[ NumBytesInRbsp++ ] | b(8) |
| } | |

TABLE 22
NAL unit header syntax (section 8.3.5.2)

| | Descriptor |
|---|---|
| nal_unit_header( ) { | |
| nal_forbidden_zero_bit | f(1) |
| nal_unit_type | u(6) |
| nal_layer_id | u(6) |
| nal_temporal_id_plus1 | u(3) |
| } | |

TABLE 23
Atlas tile layer RBSP syntax (section 8.3.6.9)

Descriptor

```
atlas_tile_layer_rbsp( ) {
  atlas_tile_header( )
  atlas_tile_data_unit( ath_id )
  rbsp_trailing_bits( )
}
```

TABLE 24
Atlas tile header syntax (section 8.3.6.11)

| | Descriptor |
|---|---|
| atlas_tile_header( ) { | |
| if( nal_unit_type >= NAL_BLA_W_LP && nal_unit_type <= NAL_RSV_IRAP_ACL_29 ) | |
| ath_no_output_of_prior_atlas_frames_flag | u(1) |
| ath_atlas_frame_parameter_set_id | ue(v) |
| ath_atlas_adaptation_parameter_set_id | ue(v) |
| ath_id | u(v) |
| ath_type | ue(v) |
| if( afps_output_flag_present_flag ) | |
| ath_atlas_output_flag | u(1) |
| ... | ... |
| byte_alignment( ) | |
| } | |

Functions for reading the information of the two types (nal_unit_type and ath_type) may be encapsulated as follows:

| sample_stream_nal_unit( ){ | |
|---|---|
| nal_unit( ) { | |
| nal_unit_header( ) { | |
| read nal_unit_type | // u(6) |
| } | |
| if ( nal_unit_type is atlas_coding_layer_type ) { | |
| atlas_tile_layer_rbsp( ) { | |
| atlas_tile_header( ){ | |
| read ath_type | // ue(v) |

```
        }
        atlas_tile_data_unit( );
      }
    }
  }
}
```

Some example embodiments make use of a profile toolset. A syntax is available in the Atlas sequence parameter set called ptl_profile_toolset_idc. The parameter ptl_profile_toolset_idc indicates the toolset combination profile component to which the CVS conforms as specified in Annex A. Bitstreams shall not contain values of ptl_profile_toolset_idc other than those specified in Annex A. Other values of ptl_profile_toolset_idc are reserved for future use by ISO/IEC.

A list of defined toolset profile components for V3C and their corresponding identifying syntax element values, e.g. ptl_profile_toolset_id, that are defined in ISO/IEC 23090-5. The syntax element ptl_profile_toolset_idc provides the primary definition of a toolset profile. However, additional syntax elements, such as ptc_one_v3c_frame_only_flag, may be used to indicate additional characteristics or restrictions of a defined profile. Reserved values of ptl_profile_toolset_idc are reserved for future use by ISO/IEC and may not be present in V3C bitstreams conforming to this version of this document.

### Example System Hardware

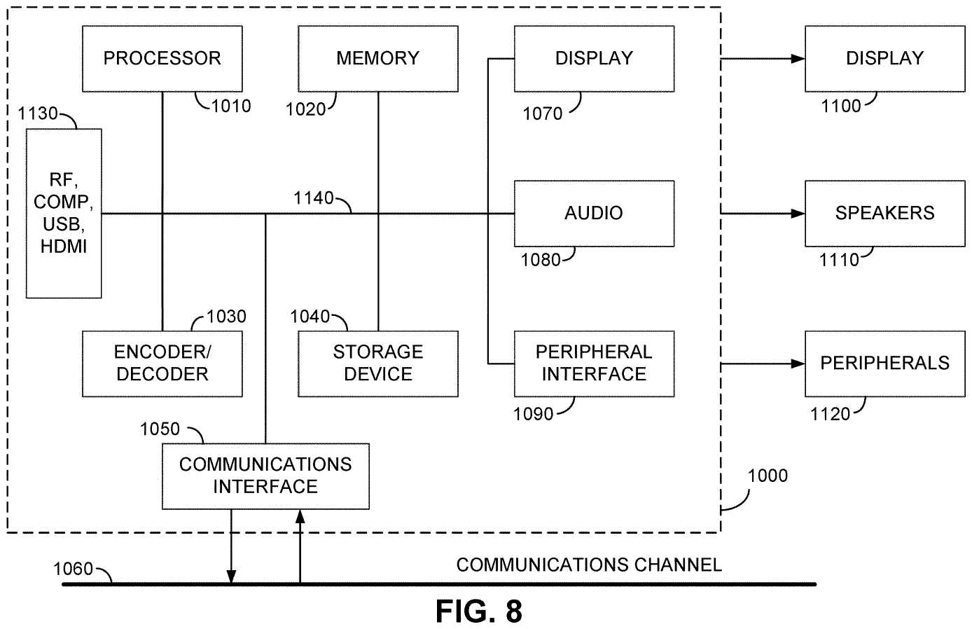

Example embodiments of encoders and/or decoders (collectively coders) configured to implement embodiments described herein may be implemented using systems such as the system of FIG. 8. FIG. 8 is a block diagram of an example of a system in which various aspects and embodiments are implemented. System 1000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded mesh or decoded mesh, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input mesh, the decoded mesh or portions of the decoded mesh, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or WC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 8, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

### Additional Embodiments

Systems and methods are described for encoding and decoding of 3D volumetric data. Volumetric data is encoded and/or decoded using a syntax that allows for different codec types, such as a point-cloud-based codec type (e.g., V-PCC), a mesh-based codec type (e.g. V-DMC), and a depth-image-based codec type (e.g. MIV). Example encoding and decoding techniques improve bitrates by allowing for syntax elements that are specific to different codec types, such as syntax elements related to atlas coding, to be signaled conditionally, e.g. only when the corresponding codec type is used for the volumetric coding. Some embodiments allow for further improvement in bitrates by inferring atlas tile header syntax element formats from NAL unit type parameters.

A method in some embodiments comprises: encoding volumetric input data with mesh-based 3D volumetric coding; wherein encoding the volumetric input data comprises encoding an atlas for the mesh-based 3D volumetric coding; wherein encoding the atlas includes: encoding, in a sequence parameter set of the atlas, a flag indicating that parameters are provided for an atlas type associated with mesh-based coding; and encoding, in the sequence parameter set, the parameters for the atlas type associated with mesh-based coding.

In some such methods, the mesh-based 3D volumetric coding is V-DMC coding.

Some methods further include encoding, in the sequence parameter set, a flag indicating that parameters are not provided for an atlas type associated with point-cloud-based coding. In some such embodiments, the point-cloud-based coding is V-PCC coding.

In some embodiments, a method comprises: encoding volumetric input data with 3D volumetric coding; wherein encoding volumetric input data comprises encoding an atlas for the 3D volumetric coding; wherein encoding the atlas includes: encoding, in a sequence parameter set of the atlas, a flag indicating whether parameters are provided for an atlas type associated with point-cloud-based coding; and encoding, in the sequence parameter set, the parameters for the atlas type associated with point-cloud-based coding, wherein at least one of the following parameters is encoded only in response to the flag indicating that parameters are provided for an atlas type associated with point-cloud-based coding:

| | |
|---|---|
| asps_use_eight_orientations_flag, | asps_extended_projection_enabled_flag, |

asps_max_number_projections_minus1,
asps_normal_axis_limits_quantization_enabled_flag,
asps_normal_axis_max_delta_value_enabled_flag, asps_patch_precedence_order_flag,

| | |
|---|---|
| asps_log2_patch_packing_block_size, | asps_patch_size_quantizer_present_flag, |
| asps_map_count_minus1, | asps_pixel_deinterleaving_enabled_flag, |
| asps_map_pixel_deinterleaving_flag, | asps_raw_patch_enabled_flag, |

asps_eom_patch_enabled_flag,

| | |
|---|---|
| asps_eom_fix_bit_count_minus1,asps_auxiliary_video_enabled_flag, | or |

asps_plr_enabled_flag.

In some embodiments, a method comprises: encoding volumetric input data with a point-cloud-based 3D volumetric coding; wherein encoding the volumetric input data comprises encoding an atlas for the point-cloud-based 3D volumetric coding; wherein encoding the atlas includes: encoding, in a frame parameter set of the atlas, a flag indicating whether parameters are provided for an atlas type associated with the point-cloud-based coding; and encoding, in the frame parameter set, the parameters for the atlas type associated with the point-cloud-based coding.

In some embodiments, a parameter afps_raw_3d_offset_bit_count_explicit_mode_flag associated with the point-cloud-based coding is encoded in the frame parameter set only in response to the flag indicating that parameters are provided for an atlas type associated with the point-cloud-based coding.

A method according to some embodiments comprises: encoding volumetric input data with a mesh-based 3D volumetric coding; wherein encoding the volumetric input data comprises encoding an atlas for the mesh-based 3D volumetric coding; wherein encoding the atlas includes: encoding, in a frame parameter set of the atlas, a flag indicating whether parameters are provided for an atlas type associated with the mesh-based coding; and encoding, in the frame parameter set, the parameters for the atlas type associated with the mesh-based 3D volumetric coding.

A method according to some embodiments comprises selecting a coding type for the encoding of volumetric input data with 3D volumetric coding; and encoding an atlas for the 3D volumetric coding; wherein encoding the atlas includes: encoding, in a video parameter set of the atlas, at least one parameter indicating the codec type of the 3D volumetric coding.

In some embodiments, the at least one parameter indicating a codec type indicates a codec type from among at least a point-cloud-based codec type (e.g. V-PCC), a mesh-based codec type (e.g. V-DMC), and a depth-image-based codec type (e.g. MIV).

In some embodiments, the at least one parameter indicating a codec type is a single parameter, the value of the single parameter indicating the codec type.

In some embodiments, the at least one parameter indicating a codec type comprises a plurality of flags, each flag corresponding to a codec type.

A method according to some embodiments comprises: encoding volumetric input data with 3D volumetric coding; wherein encoding the volumetric input data comprises encoding an atlas for the 3D volumetric coding; wherein encoding the atlas includes: encoding a type parameter indicating a codec type of the 3D volumetric coding; and encoding, in an atlas tile header, atlas parameters for an atlas type associated with point-cloud-based coding, wherein at least one of the following parameters is encoded only in response to the type parameter indicating a point-cloud-based codec type:

| | |
|---|---|
| ath_pos_min_d_quantizer, | ath_pos_delta_max_d_quantizer, |
| ath_patch_size_x_info_quantizer, | ath_patch_size_y_info_quantizer, or |

ath_raw_3d_offset_axis_bit_count_minus1.

In some embodiments, the type parameter is encoded in a video parameter set of the atlas.

In some embodiments, the type parameter indicates a codec type from among at least a point-cloud-based codec type, a mesh-based codec type, and a depth-image-based codec type.

In some embodiments, the type parameter indicates a codec type from among at least V-PCC, V-DMC, and MIV.

A method according to some embodiments comprises: encoding volumetric input data with 3D volumetric coding; wherein encoding the volumetric input data comprises encoding an atlas for the 3D volumetric coding; wherein encoding the atlas includes: encoding a type parameter indicating a codec type of the 3D volumetric coding; and encoding, in an atlas tile data unit, a set of patch information data selected from among a plurality of available sets of patch information data, wherein the set of patch information data is selected based on the indicated codec type.

In some embodiments, the type parameter is encoded in a video parameter set of the atlas.

In some embodiments, the type parameter indicates a codec type from among at least a point-cloud-based codec type, a mesh-based codec type, and a depth-image-based codec type.

In some embodiments, the type parameter indicates a codec type from among at least V-PCC, V-DMC, and MIV.

A method according to some embodiments comprises: encoding volumetric input data with 3D volumetric coding; wherein encoding the volumetric input data comprises encoding an atlas for the 3D volumetric coding; wherein encoding the atlas includes encoding the atlas using at least one network abstraction layer (NAL) unit, each NAL unit having a NAL unit type parameter; and wherein encoding the atlas further includes encoding an atlas tile header syntax element in a NAL unit, the atlas tile header syntax element having a format based on the NAL unit type parameter.

In some such embodiments, the format of the atlases tile header syntax element is not signaled in the atlas tile header syntax element.

In some embodiments, the format of the atlas tile header syntax element is a format associated with one of the following formats: P_TILE, SKIP_TILE, and I_TILE.

A method in some embodiments comprises: decoding mesh-based 3D volumetric coding data; wherein decoding the mesh-based 3D volumetric coding data comprises decoding an atlas for the mesh-based 3D volumetric coding; wherein decoding the atlas includes: decoding, from a sequence parameter set of the atlas, a flag indicating that parameters are provided for an atlas type associated with mesh-based coding; and decoding, from the sequence parameter set, the parameters for the atlas type associated with mesh-based coding.

In some embodiments, the mesh-based 3D volumetric coding is V-DMC coding.

Some embodiments further comprise decoding, from the sequence parameter set, a flag indicating that parameters are not provided for an atlas type associated with point-cloud-based coding.

A method according to some embodiments comprises: decoding 3D volumetric coded data; wherein decoding the 3D volumetric data comprises decoding an atlas for the 3D volumetric coding; wherein decoding the atlas includes: decoding, from a sequence parameter set of the atlas, a flag indicating whether parameters are provided for an atlas type associated with point-cloud-based coding; and decoding, from the sequence parameter set, the parameters for the atlas type associated with point-cloud-based coding, wherein at least one of the following parameters is decoded only in response to the flag indicating that parameters are provided for an atlas type associated with point-cloud-based coding:

| | |
|---|---|
| asps_use_eight_orientations_flag, | asps_extended_projection_enabled_flag, |

asps_max_number_projections_minus1,
asps_normal_axis_limits_quantization_enabled_flag,
asps_normal_axis_max_delta_value_enabled_flag, asps_patch_precedence_order_flag,

| | |
|---|---|
| asps_log2_patch_packing_block_size, | asps_patch_size_quantizer_present_flag, |
| asps_map_count_minus1, | asps_pixel_deinterleaving_enabled_flag, |
| asps_map_pixel_deinterleaving_flag, | asps_raw_patch_enabled_flag, |

asps_eom_patch_enabled_flag,

| | |
|---|---|
| asps_eom_fix_bit_count_minus1,asps_auxiliary_video_enabled_flag, | or |

asps_plr_enabled_flag.

A method according to some embodiments comprises: decoding point-cloud-based 3D volumetric coding data; wherein decoding the point-cloud-based 3D volumetric data comprises decoding an atlas for the point-cloud-based 3D volumetric coding; wherein decoding the atlas includes: decoding, from a frame parameter set of the atlas, a flag indicating whether parameters are provided for an atlas type associated with the point-cloud-based coding; and decoding, from the frame parameter set, the parameters for the atlas type associated with the point-cloud-based coding.

In some embodiments, a parameter afps_raw_3d_offset_bit_count_explicit_mode_flag associated with the point-cloud-based coding is decoded from the frame parameter set only in response to the flag indicating that parameters are provided for an atlas type associated with the point-cloud-based coding.

A method according to some embodiments comprises: decoding mesh-based 3D volumetric coding data; wherein decoding the mesh-based 3D volumetric coding data comprises decoding an atlas for the mesh-based 3D volumetric coding; wherein decoding the atlas includes: decoding, from a frame parameter set of the atlas, a flag indicating whether parameters are provided for an atlas type associated with the mesh-based coding; and decoding, from the frame parameter set, the parameters for the atlas type associated with the mesh-based coding.

A method according to some embodiments comprises: decoding 3D volumetric coding data; wherein decoding 3D volumetric coding data comprises decoding an atlas for the 3D volumetric coding; wherein decoding the atlas includes: decoding, from a video parameter set of the atlas, at least one parameter indicating a codec type of the 3D volumetric coding; and decoding the atlas according to the codec type.

In some embodiments, the at least one parameter indicating a codec type indicates a codec type from among at least a point-cloud-based codec type and a mesh-based codec type. In some embodiments, the at least one parameter indicating a codec type indicates a codec type from among at least a point-cloud-based codec type, a mesh-based codec type, and a depth-image-based codec type. In some embodiments, the at least one parameter indicating a codec type indicates a codec type from among at least V-PCC, V-DMC, and MIV.

In some embodiments, the at least one parameter indicating a codec type is a single parameter, the value of the single parameter indicating the codec type.

In some embodiments, the at least one parameter indicating a codec type comprises a plurality of flags, each flag corresponding to a codec type.

A method according to some embodiments comprises: decoding 3D volumetric coding data; wherein decoding the volumetric input data comprises decoding an atlas for the 3D volumetric data; wherein decoding the atlas includes: decoding a type parameter indicating a codec type of the 3D volumetric coding; and decoding, from an atlas tile header, atlas parameters for an atlas type associated with point-cloud-based coding, wherein at least one of the following parameters is decoded only in response to the type parameter indicating a point-cloud-based codec type:

| | |
|---|---|
| ath_pos_min_d_quantizer, | ath_pos_delta_max_d_quantizer, |
| ath_patch_size_x_info_quantizer, | ath_patch_size_y_info_quantizer, or |

ath_raw_3d_offset_axis_bit_count_minus1.

According to some such embodiments, the type parameter is decoded from a video parameter set of the atlas.

In some embodiments, the type parameter indicates a codec type from among at least a point-cloud-based codec type, a mesh-based codec type, and a depth-image-based codec type.

In some embodiments, the type parameter indicates a codec type from among at least V-PCC, V-DMC, and MIV.

A method according to some embodiments comprises: decoding 3D volumetric coding data; wherein decoding the 3D volumetric coding data comprises decoding an atlas for the 3D volumetric coding; wherein decoding the atlas includes: decoding a type parameter indicating a codec type of the 3D volumetric coding; and decoding, from an atlas tile data unit, a set of patch information data selected from among a plurality of available sets of patch information data, wherein the set of patch information data is selected based on the indicated codec type.

In some embodiments, the type parameter is decoded from a video parameter set of the atlas.

In some embodiments, the type parameter indicates a codec type from among at least a point-cloud-based codec type, a mesh-based codec type, and a depth-image-based codec type.

In some embodiments, the type parameter indicates a codec type from among at least V-PCC, V-DMC, and MIV.

A method according to some embodiments includes: decoding 3D volumetric coding data; wherein decoding the 3D volumetric coding data comprises decoding an atlas for the 3D volumetric coding, the atlas including at least one network abstraction layer (NAL) unit, each NAL unit having a NAL unit type parameter; determining a format of an atlas tile header syntax element based on the NAL unit type parameter of a NAL unit containing the atlas tile header syntax element; and decoding the atlas tile header syntax element based on the determined format.

In some such embodiments, the format of the atlases tile header syntax element is not signaled in the atlas tile header syntax element.

In some embodiments, the format of the atlas tile header syntax element is a format associated with one of the following formats: P_TILE, SKIP_TILE, and I_TILE.

Some embodiments include an encoder comprising one or more processors configured to perform the methods described herein.

Some embodiments include a bitstream encoded using the methods described herein.

Some embodiments include a computer-readable medium storing a bitstream encoded using the methods described herein. The medium may be a non-transitory medium.

Some embodiments include a computer-readable medium storing instructions operative, when executed on one or more processors, to perform the methods described herein. The medium may be a non-transitory medium.

Some embodiments include a decoder comprising one or more processors configured to perform the methods described herein.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory. (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A mesh decoding method comprising:
decoding mesh-based 3D volumetric coding data;
wherein decoding the mesh-based 3D volumetric coding data comprises decoding an atlas for the mesh-based 3D volumetric coding;
wherein decoding the atlas includes:
decoding first atlas type information from a sequence parameter set of the atlas; and
in response to a determination that the first atlas type information identifies an atlas type associated with mesh-based coding, decoding, from the sequence parameter set, a first set of parameters for the atlas type associated with mesh-based coding.

2. A mesh decoding apparatus comprising one or more processors configured to perform at least:
decoding mesh-based 3D volumetric coding data;
wherein decoding the mesh-based 3D volumetric coding data comprises decoding an atlas for the mesh-based 3D volumetric coding;
wherein decoding the atlas includes:
decoding first atlas type information from a sequence parameter set of the atlas; and
in response to a determination that the first atlas type information identifies an atlas type associated with mesh-based coding, decoding, from the sequence parameter set, a first set of parameters for the atlas type associated with mesh-based coding.

3. The method of claim 1, wherein decoding the atlas further includes:
decoding second atlas type information from an atlas frame parameter set; and
in response to a determination that the second atlas type information identifies an atlas type associated with mesh-based coding, decoding, from the atlas frame parameter set, a second set of parameters for the atlas type associated with mesh-based coding.

4. The method of claim 1, wherein the first atlas type information includes an atlas type parameter, the parameter having a value indicating that the atlas type is associated with mesh-based coding, further comprising:
in response to a determination that the first atlas type information identifies an atlas type associated with mesh-based coding, decoding, from an atlas frame parameter set, a second set of parameters for the atlas type associated with mesh-based coding.

5. The method of claim 1, wherein, in response to the determination that the atlas type is associated with mesh-based coding, the following parameter is not coded in the sequence parameter set: afps_raw_3d_offset_bit_count_explicit_mode_flag.

6. The method of claim 1, further comprising decoding third atlas type information from a video parameter set, wherein, in response to a determination that the third atlas type information does not indicate an atlas type associated with point cloud coding, at least one of the following parameters is not coded in an atlas tile header: ath_pos_min_d_quantizer, ath_pos_delta_max_d_quantizer, ath_patch_size_x_info_quantizer, ath_patch_size_y_info_quantizer, or ath_raw_3d_offset_axis_bit_count_minus1.

7. The apparatus of claim 2, further comprising decoding third atlas type information from a video parameter set, further comprising, in response to a determination that the third atlas type information indicates an atlas type associated with mesh-based coding, decoding mesh-based patch information from an atlas tile data unit.

8. The apparatus of claim 2, wherein the first atlas type information includes a plurality of flags, each flag being associated with a respective atlas type, a first one of the flags being associated with mesh-based coding and having a value indicating that the atlas type is associated with mesh-based coding.

9. The apparatus of claim 2, wherein the first atlas type information includes an atlas type parameter, the parameter having a value indicating that the atlas type is associated with mesh-based coding.

10. The apparatus of claim 2, wherein the first set of parameters for the atlas type associated with mesh-based coding include one or more of the following:
SubdivisionIterationCount, LiftingQPs[0], LiftingQPs[1], LiftingQPs[2], InterpolateDisplacementNormals, AddReconstructedNormals, DisplacementReversePacking, WidthDispVideo, or HeightDispVideo.

11. (canceled)

12. A mesh encoding method comprising:
encoding mesh-based 3D volumetric coding data;
wherein encoding the mesh-based 3D volumetric coding data comprises encoding an atlas for the mesh-based 3D volumetric coding;
wherein encoding the atlas includes:
encoding first atlas type information from a sequence parameter set of the atlas; and
in response to a determination that the first atlas type information identifies an atlas type associated with mesh-based coding, encoding, in the sequence parameter set, a first set of parameters for the atlas type associated with mesh-based coding.

13. A mesh encoding apparatus comprising one or more processors configured to perform at least:
encoding mesh-based 3D volumetric coding data;
wherein encoding the mesh-based 3D volumetric coding data comprises encoding an atlas for the mesh-based 3D volumetric coding;
wherein encoding the atlas includes:
encoding first atlas type information from a sequence parameter set of the atlas; and
in response to a determination that the first atlas type information identifies an atlas type associated with mesh-based coding, encoding, in the sequence parameter set, a first set of parameters for the atlas type associated with mesh-based coding.

14. The method of claim 12, wherein encoding the atlas further includes:
encoding second atlas type information in an atlas frame parameter set; and
in response to a determination that the second atlas type information identifies an atlas type associated with mesh-based coding, encoding, in the atlas frame parameter set, a second set of parameters for the atlas type associated with mesh-based coding.

15. The method of claim 12, wherein the first atlas type information includes an atlas type parameter, the parameter having a value indicating that the atlas type is associated with mesh-based coding, further comprising:
in response to a determination that the first atlas type information identifies an atlas type associated with mesh-based coding, encoding, in an atlas frame parameter set, a second set of parameters for the atlas type associated with mesh-based coding.

16. The method of claim 12, wherein, in response to the determination that the atlas type is associated with mesh-based coding, the following parameter is not coded in the sequence parameter set: afps_raw_3d_offset_bit_count_explicit_mode_flag.

17. The method of claim 12, further comprising encoding third atlas type information in a video parameter set, wherein, in response to a determination that the third atlas type information does not indicate an atlas type associated with point cloud coding, at least one of the following parameters is not coded in an atlas tile header: ath_pos_min_d_quantizer, ath_pos_delta_max_d_quantizer, ath_patch_size_x_info_quantizer, ath_patch_size_y_info_quantizer, or ath_raw_3d_offset_axis_bit_count_minus1.

18. The apparatus of claim 13, further comprising encoding third atlas type information from a video parameter set, further comprising, in response to a determination that the third atlas type information indicates an atlas type associated with mesh-based coding, decoding mesh-based patch information from an atlas tile data unit.

19. The apparatus of claim 13, wherein the first atlas type information includes a plurality of flags, each flag being associated with a respective atlas type, a first one of the flags being associated with mesh-based coding and having a value indicating that the atlas type is associated with mesh-based coding.

20. The apparatus of claim 13, wherein the first atlas type information includes an atlas type parameter, the parameter having a value indicating that the atlas type is associated with mesh-based coding.

21. The apparatus of claim 13, wherein the first set of parameters for the atlas type associated with mesh-based coding include one or more of the following:
SubdivisionIterationCount, LiftingQPs[0], LiftingQPs[1], LiftingQPs[2], InterpolateDisplacementNormals, AddReconstructedNormals, DisplacementReversePacking, WidthDispVideo, or HeightDispVideo.

22-26. (canceled)
